(19) United States
(12) Patent Application Publication
(10) Pub. No.: US 2020/0396012 A1
(43) Pub. Date: Dec. 17, 2020

(54) ELECTRONIC DEVICE, METHOD AND STORAGE MEDIUM FOR WIRELESS COMMUNICATION SYSTEM

(71) Applicant: Sony Corporation, Tokyo (JP)

(72) Inventors: Wendong LIU, Beijing (CN); Zhaocheng WANG, Beijing (CN); Jianfei CAO, Beijing (CN)

(73) Assignee: Sony Corporation, Tokyo (JP)

(21) Appl. No.: 16/960,589

(22) PCT Filed: Apr. 22, 2019
(86) PCT No.: PCT/CN2019/083612

§ 371 Date: Jul. 8, 2020

(30) Foreign Application Priority Data
Apr. 24, 2018 (CN) 201810372665.3

(51) Int. Cl. H04B 17/309; H04B 17/382; H04B 7/06; H04B 7/08

(52) U.S. Cl. CPC H04B 17/309; H04B 7/0857; H04B 7/0695; H04B 17/382

(57) ABSTRACT

The present disclosure relates to an electronic device, a method, and storage medium for a wireless communication system. Various embodiments regarding managing beam pairs are described. In an embodiment, an electronic device used on a terminal device side in a wireless communication system can comprise a processing circuit that can be configured to determine a beam pair quality indication of a plurality of downlink beam pairs. The beam pair quality indication can represent quality of service that can be offered by a corresponding beam pair, and can comprise a plurality of beam pair quality indication elements. The plurality of beam pair quality indication elements comprise at least degree of stability of the measurement metrics.

### TECHNICAL FIELD

The present disclosure relates generally to wireless communication system, and in particular, to techniques for managing beam pair links.

### BACKGROUND

In recent years, with the development and wide application of mobile Internet technology, wireless communication has unprecedentedly met people's needs for voice and data communication. In order to provide even higher communication quality and capacity, wireless communication system employs various technologies at different layers, such as Beamforming techniques. Beamforming can provide beamforming gain to compensate for loss of radio signals by increasing the directivity of antenna transmission and/or reception. In future wireless communication systems (such as 5G systems like NR (New Radio) system, for example), the number of antenna ports at the base station and terminal device sides will further increase. For example, by using millimeter-wave (mmWave) communication, the number of antenna ports at the base station side may increase to hundreds or even more, constituting a Massive MIMO system. Thus, in large-scale antenna systems, beamforming will have a larger application space.

In the beam sweeping technology, the matching transmitting beam and receiving beam between a base station and a terminal device is found via a Beam Sweeping process, thereby establishing a beam pair link (BPL) between the base station and the terminal device. The beam sweeping can be carried out in the uplink and downlink respectively, accordingly, an uplink and downlink beam pair links can be established. The beam pair links appear not stable enough due to the links being susceptible to factors like environment etc. For example, in the case that there is line-of-sight obstruction or terminal device moving or rotating, the quality of beam pair links may deteriorate or even fail. This phenomenon is more pronounced at high frequencies. Accordingly, it is necessary to switch the beam pair link during communication.

### SUMMARY

One aspect of the present disclosure relates to an electronic device for a terminal device side in a wireless communication system. In one embodiment, the electronic device can comprise a processing circuit that can be configured to determine a beam pair quality indication of a plurality of downlink beam pairs, the beam pair quality indication representing quality of service (QoS) that can be offered by a corresponding beam pair. The beam pair quality indication can comprise a plurality of beam pair quality indication elements, the plurality of beam pair quality indication elements comprising at least degree of stability of a measurement metrics.

One aspect of the present disclosure relates to an electronic device for a base station side in a wireless communication system. In one embodiment, the electronic device comprises a processing circuit that can be configured to determine a beam pair quality indication of a plurality of uplink beam pairs, the beam pair quality indication representing quality of service that can be offered by a corresponding beam pair. The beam pair quality indication can comprise a plurality of beam pair quality indication elements, the plurality of beam pair quality indication elements comprising at least degree of stability of a measurement metrics.

Another aspect of the present disclosure relates to a method for wireless communication. In one embodiment, the method can comprise determining, by a terminal device, a beam pair quality indication of a plurality of downlink beam pairs, the beam pair quality indication representing quality of service (QoS) that can be offered by a corresponding beam pair. The beam pair quality indication can comprise a plurality of beam pair quality indication elements, the plurality of beam pair quality indication elements comprising at least degree of stability of a measurement metrics.

Another aspect of the present disclosure relates to a method for wireless communication. In one embodiment, the method can comprise determining, by a base station, a beam pair quality indication of a plurality of uplink beam pairs, the beam pair quality indication representing quality of service that can be offered by a corresponding beam pair. The beam pair quality indication can comprise a plurality of beam pair quality indication elements, the plurality of beam pair quality indication elements comprising at least degree of stability of a measurement metrics.

Yet another aspect of the present disclosure relates to a computer-readable storage medium having one or more instructions stored thereon. In some embodiments, the one or more instructions can, when executed by one or more processors of an electronic device, cause the electronic device to perform the methods in accordance with various embodiments of the present disclosure.

Still another aspect of the present disclosure relates to various apparatus, comprising components or units for performing operations of the methods in accordance with embodiments of the present disclosure.

The above summary is provided to summarize some exemplary embodiments in order to provide a basic understanding of the various aspects of the subject matter described herein. Therefore, the above-described features are merely examples and should not be construed as limiting the scope or spirit of the subject matter described herein in any way. Other features, aspects, and advantages of the subject matter described herein will become apparent from the Detailed Description described below in conjunction with the drawings.

### DRAWINGS

A better understanding of the present disclosure can be achieved by referring to the detailed description given hereinafter in connection with the accompanying drawings, wherein same or similar reference signs are used to indicate same or similar components throughout the figures. The figures are included in the specification and form a part of the specification along with the following detailed descriptions, for further illustrating embodiments herein and explaining the theory and advantages of the present disclosure. Wherein:

FIG. 1 depicts an exemplary beam scanning process in a wireless communication system.

FIGS. 2A to 2B illustrates an example of a downlink BPL in accordance with an embodiment of the present disclosure.

FIG. 3A illustrates an exemplary electronic device for a terminal device side in accordance with an embodiment of the present disclosure.

FIG. 3B illustrates an exemplary electronic device for a base station side in accordance with an embodiment of the present disclosure.

FIGS. 4A to 4C illustrate an exemplary process of obtaining a measurement metrics in accordance with an embodiment of the present disclosure.

FIG. 5 illustrates an exemplary operation for obtaining elements of the beam pair quality indication in accordance with an embodiment of the present disclosure.

FIG. 6 illustrates an example of ranking beam pairs in accordance with an embodiment of the present disclosure.

FIGS. 7A to 7B illustrate examples of beam pairs in accordance with an embodiment of the present disclosure.

FIG. 7C illustrates an example of a communication service in accordance with an embodiment of the present disclosure.

FIG. 8 illustrates one example process of matching a beam pair with a communication service in accordance with an embodiment of the present disclosure.

FIG. 9 illustrates an example operation of processing a measurement metrics in accordance with an embodiment of the present disclosure.

FIG. 10 illustrates an exemplary application of beam pair quality indication in an NR system in accordance with an embodiment of the present disclosure.

FIGS. 11A to 11D illustrate an exemplary signaling flow for selecting a beam pair in accordance with an embodiment of the present disclosure.

FIGS. 12A and 12B illustrate an example method for communication in accordance with an embodiment of the present disclosure.

FIG. 13 is a block diagram showing an example structure of a personal computer as an information processing device that can be employed in an embodiment of the present disclosure;

FIG. 14 is a block diagram showing a first example of a schematic configuration of a gNB to which the technology of the present disclosure may be applied;

FIG. 15 is a block diagram showing a second example of a schematic configuration of a gNB to which the technology of the present disclosure can be applied;

FIG. 16 is a block diagram showing an example of a schematic configuration of a smartphone to which the technology of the present disclosure can be applied;

FIG. 17 is a block diagram showing an example of a schematic configuration of a car navigation device to which the technology of the present disclosure can be applied; and

FIG. 18 illustrates an example of performance simulation for beam pair selection in accordance with an embodiment of the present disclosure.

While the embodiments described in the present disclosure are susceptible to various modifications and alternative forms, the specific embodiments are illustrated in the drawings and are described in detail herein. It should be understood, however, that the drawings and the detailed description thereof are not intended to limit the embodiments to the particular forms disclosed, rather, it is intended to cover all modifications, equivalents, and alternatives falling within the spirit and scope of the claims.

### DETAILED DESCRIPTION

The following describes representative applications of various aspects of the device and method according to the present disclosure. The description of these examples is merely to add context and help to understand the described embodiments. Therefore, it is clear to those skilled in the art that the embodiments described below can be implemented without some or all of the specific details. In other instances, well-known process steps have not been described in detail to avoid unnecessarily obscuring the described embodiments. Other applications are also possible, and the solution of the present disclosure is not limited to these examples.

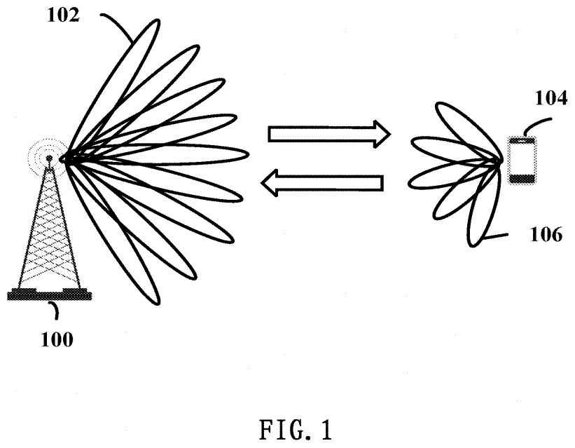

An example of a beam sweeping process in a wireless communication system will be described below with reference to FIG. 1. The right arrow in FIG. 1 indicates the downlink direction from a base station 100 to a terminal device 104, and the left arrow indicates the uplink direction from the terminal device 104 to the base station 100. As shown in FIG. 1, the base station 100 includes n_{t_DL} downlink transmitting beams (n_{t_DL} is a natural number greater than or equal to 1, and exemplified in FIG. 1 as n_{t_DL}=9), and the terminal device 104 includes n_{r_DL} downlink receiving beams (n_{r_DL} is a natural number greater than or equal to 1, exemplified in FIG. 1 as n_{r_DL}=5). In addition, in the wireless communication system shown in FIG. 1, the number of uplink receiving beams n_{r_UL} of the base station 100 and the coverage of each beam are the same as those of downlink transmitting beams, and the number of uplink transmitting beams n_{t_UL} of the terminal device 104 and the coverage of each beam are the same as those of downlink receiving beams. It should be understood that, according to the system requirements and settings, the coverage and the number of uplink receiving beams and downlink transmitting beams of a base station may be different, and the same is true for a terminal device.

As shown in FIG. 1, during a downlink beam sweeping process, each downlink transmitting beam 102 of the n_{t_DL} downlink transmitting beams of the base station 100 transmits n_{r_DL} downlink reference signals to the terminal device 104, and the terminal device 104 receives the n_{r_DL} downlink reference signals through the n_{r_DL} downlink receiving beams respectively. In this way, the n_{t_DL} downlink transmitting beams of the base station 100 sequentially transmit n_{t_DL}×n_{r_DL} downlink reference signals to the terminal device 104, and each downlink receiving beam 106 of the terminal device 104 receives n_{t_DL} downlink reference signals, that is, the n_{r_DL} downlink receiving beams of the terminal device 104 receive a total of n_{t_DL}×n_{r_DL} downlink reference signals from the base station 100. The terminal device 104 measures the n_{t_DL}×n_{r_DL} downlink reference signals to obtain measurement metrics. In the embodiments of the present disclosure, the downlink transmitting beam of the base station 100 and the downlink receiving beam of the terminal device 104 when the measurement metrics is better (for example, better than a predetermined threshold level) or the best may be determined to be matched, and they form a matched beam pairs in the downlink. In an embodiment of the present disclosure, one or more of the matched beam pairs in the downlink can be selected as candidate beam pair(s) and thereby establishing candidate BPL(s). In an embodiment of the present disclosure, one or more of the candidate beam pairs in the downlink can be selected as activated beam pair(s) and thereby establishing activated BPL(s).

During an uplink beam sweeping process, similar to the downlink beam sweeping, each uplink transmitting beam 106 of the n_{t_UL} uplink transmitting beams of the terminal device 104 transmits the n_{r_UL} uplink reference signals to the base station 100, and the base station 100 receives the n_{r_UL} uplink reference signals through the n_{r_UL} uplink receiving beams respectively. In this way, the n_{t_UL} uplink transmitting beams of the terminal device 104 sequentially transmit n_{t_UL}×n_{r_UL} uplink reference signals to the base station 100, and each uplink receiving beam 102 of the base station 100 receives n_{t_UL} uplink reference signals, that is, the n_{r_UL} uplink receiving beams of the base station 100 receive a total of n_{r_UL}×n_{t_UL} uplink reference signals from the terminal device 104. The base station 100 measures the n_{r_UL}×n_{t_UL} uplink reference signals to obtain measurement metrics. In the embodiments of the present disclosure, the uplink transmitting beam of the terminal device 104 and the uplink receiving beam of the base station 100 when the measurement metrics is better (for example, better than a predetermined threshold level) or the best may be determined to be matched, and they form an matched beam pairs in the uplink. In an embodiment of the present disclosure, one or more of the matched beam pairs in the uplink can be selected as candidate beam pair(s) and thereby establishing candidate BPL(s). In an embodiment of the present disclosure, one or more of the candidate beam pairs in the uplink can be selected as activated beam pair(s) and thereby establishing activated BPL(s).

The above process of determining matched beam pairs of a base station and a terminal device through beam sweeping is sometimes referred to as a Beam Training process. It should be understood that the coverage and the number of uplink receiving beams and downlink transmitting beams of a base station may be different and the coverage and the number of uplink transmitting beams and downlink receiving beams of a terminal device may be different, and the above determination operation can still be similarly carried out.

Receiving beams and transmitting beams of a base station and a terminal device can be generated by a Discrete Fourier Transform (DFT) vector. A downlink transmitting beam at a base station side is used below as an example for description. An uplink receiving beam at a base station side and a transmitting beam and a receiving beam at a terminal device side can also be generated by similar methods.

For example, assuming that a base station side is equipped with nₜ transmitting antennas, an equivalent channel from the base station to a terminal device can be expressed as one nₜ×1 vector H. The DFT vector u can be expressed as:

$$u = {[ \begin{matrix}1 & {e}^{j \frac{2 π}{C}} & … & {e}^{j \frac{2 π ( {n}_{t} - 1 )}{C}}\end{matrix} ]}^{T} \qquad [ Equation 1 ]$$

Wherein, the length of the DFT vector u is nₜ, C represents a parameter for adjusting the beam width and beamforming gain, and “T” represents a transposition operator.

One transmitting beam of the base station can be obtained by multiplying the equivalent channel H from the base station to the terminal device by the DFT vector u (for example, one of the downlink transmitting beams shown in FIG. 1).

In one embodiment, the parameter C for adjusting the beam width and beamforming gain in Equation 1 can be expressed by the product of two parameters O₂ and N₂, and by adjusting the two parameters O₂ and N₂, respectively, the beam width and beamforming gain can be adjusted. Generally, the larger the number of antennas nₜ or the larger the parameter C (for example, the product of O₂ and N₂), the stronger the spatial directivity of the obtained beam, but the narrower the beam width in general. In one embodiment, O₂=1 and N₂=1 can be taken, and the DFT vector u thus obtained is a vector in which nₜ elements are all 1.

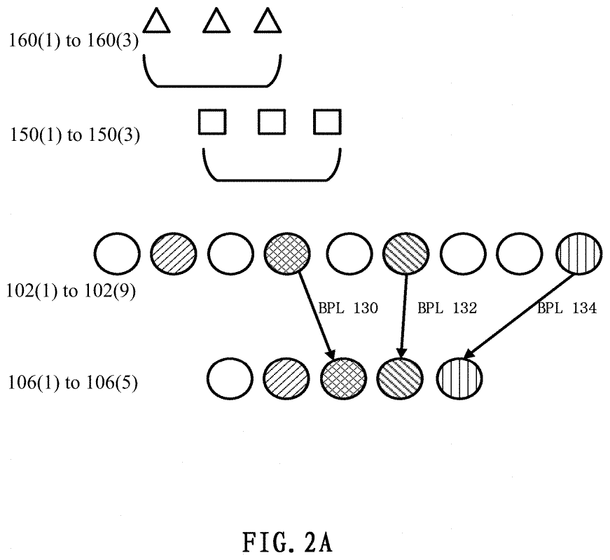

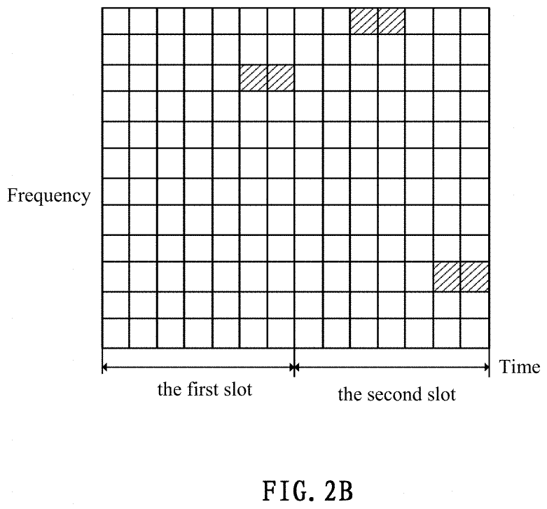

FIG. 2A illustrates an example of a BPL in a wireless communication system in accordance with an embodiment of the present disclosure. A BPL is a communication link established by beam pairs in uplink/downlink. In general, the beam pairs herein and BPLs established through them can be used interchangeably. FIG. 2A illustrates an example of a BPL for the downlink. In FIG. 2A, the nine transmitting beams 102 of the base station 100 in FIG. 1 are denoted as 102 (1) to 102 (9) respectively, and the five receiving beams 106 of the terminal device 106 in FIG. 1 are denoted as 106 (1) To 106 (5) respectively. In FIG. 2A, four matched beam pairs determined through the beam sweeping process are illustrated with different legends. For example, the transmitting beam 102 (2) and the receiving beam 106 (2) form a matched beam pair. Three of the four beam pairs are selected as candidate beam pairs and corresponding BPLs 130, 132, and 134 are established, and the BPL 130 is selected as the activated BPL. The activated BPL is a BPL used to transmit data/control signals between a base station and a terminal device. There may be no data/control signal transmission on the candidate BPL, but reference signals may still be transmitted through the candidate BPL in order to track the quality of the candidate BPL. In an embodiment, based on changes in beam pair quality/performance, the activated BPL may be switched. For example, the activated BPL may be switched from BPL 130 to BPL 132 based on certain criteria.

In an embodiment of the present disclosure, the transmitting beams 102 (1) to 102 (9) may have one or more reference signal ports, respectively. In FIG. 2A, the transmitting beam 102 (4) has three reference signal ports 150 (1) to 150 (3). The reference signal ports 150 (1) to 150 (3) may correspond to one or more sets of reference signal resources, respectively. In FIG. 2A, the reference signal port 150 (3) corresponds to three sets of reference signal resources 160 (1) to 160 (3). Therefore, there may be a correspondence between a reference signal resource and a transmitting beam. FIG. 2B illustrates an exemplary reference signal resource in accordance with an embodiment of the present disclosure. In FIG. 2B, there are three sets of reference signal resources (as shown in the shadow legend), which may correspond to the above reference signal resources 160 (1) to 160 (3), respectively. Based on the pre-allocation of the system, each set of reference signal resources 160 (1) to 160 (3) corresponds to a certain time-frequency resource. FIG. 2B only illustrates reference signal resources within 1 subframe. It can be understood that there may be appropriate reference signal resources in each subframe.

FIGS. 2A and 2B illustrate only example of BPL in the downlink, but those skilled in the art can similarly understand the case of BPL in the uplink through this example.

In an embodiment of the present disclosure, a beam pair quality indication (BQI) of a beam pair may be determined to indicate the performance/quality of the corresponding BPL or the quality of service that it can offer. The beam pair quality indication can comprise a plurality of BQI elements. In some embodiments, the plurality of BQI elements can comprise at least degree of stability of a measurement metrics. In some embodiments, the plurality of BQI elements may further comprise an instantaneous value and/or a long-term value of the measurement metrics. In the embodiments of the present disclosure, the measurement metrics can comprise any measurement result on the performance of a matched beam pair or an established BPL, such as the received signal power, quality, signal-to-interference and noise ratio, SINR, and signal-to-noise ratio, SNR, etc. Reference signals transmitted by the matched beam pairs, the candidate beam pairs, and/or the activated beam pairs (or corresponding BPLs) can be measured (that is, the reference signals are measurement objects) to obtain the measurement metrics of corresponding beam pairs (or BPLs), and/or the data transmitted by activated beam pairs (or corresponding BPLs) can be measured (that is, the data transmissions are measurement objects) to obtain the measurement metrics of corresponding beam pairs (or BPLs).

For example, in the beam training process, a plurality of instantaneous values of the measurement metrics of each matched beam pair can be obtained. The measurement metrics for a reference signal in the beam training process can comprise, but are not limited to, a reference signal received power, RSRP, a reference signal received quality, RSRQ, and/or a signal-to-interference and noise ratio, SINR. After the candidate beam pairs and the activated beam pairs are selected and the corresponding BPLs are established, a plurality of instantaneous values of the measurement metrics of each candidate beam pair and the activated beam pair can be obtained. Since there is data transmission on the activated beam pair, the signal-to-interference and noise ratio, SINR or signal-to-noise ratio, SNR of the received data can be obtained as measurement metrics. Since the reference signal can be transmitted on the candidate beam pair, the reference signal received power, RSRP, the reference signal received quality, RSRQ, and/or the signal-to-interference and noise ratio SINR can be obtained as measurement metrics.

In the embodiments of the present disclosure, by processing of instantaneous values of the measurement metrics, the degree of stability and/or long-term value of the measurement metrics can be obtained. In this way, by obtaining the measurement metrics of each beam pair and processing of measurement metrics, a plurality of BQI elements can be obtained. Each BQI element can characterize the performance of the corresponding beam pair from different perspectives, which facilitates managing BPL with different targets (for example, establishing BPL, switching BPL, etc.). For example, degree of stability of the measurement metrics can characterize the stability of a beam pair. Selection of activated beam pairs (or candidate beam pairs) based on this BQI element helps to reduce the possibility of switching BPL, thereby reducing communication interruption and power overhead usually caused by switching BPL. As another example, long-term value and instantaneous value of a measurement metrics can characterize the gain level of a beam pair (for example, characterizing by RSRP or RSRQ) or the communication quality (for example, characterizing by SINR or SNR). Selection of activated beam pairs (or candidate beam pairs) based on this BQI element helps to ensure the data rate level or transmission quality of the communication, thereby meeting the data rate requirement for instantaneous or within a period of time for the communication. In the embodiments of the present disclosure, since a plurality of BQI elements are obtained, the BPLs can be managed based on various criteria to achieve different targets, as described in detail below.

### Exemplary Electronic Devices

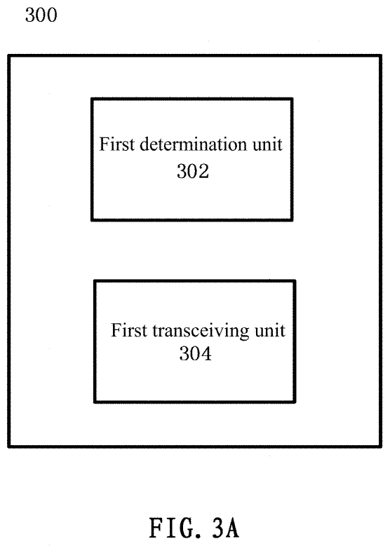

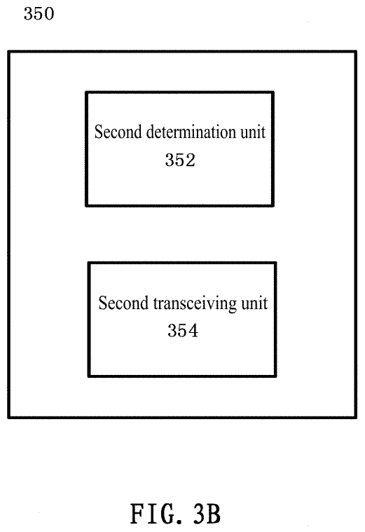

FIG. 3A illustrates an exemplary electronic device for a terminal device side in accordance with an embodiment of the present disclosure, where the terminal device can be used in various wireless communication systems. The electronic device 300 illustrated in FIG. 3A can include various units to implement various embodiments according to the present disclosure. In this example, the electronic device 300 can include a first determination unit 302 and a first transceiving unit 304. In different implementations, the electronic device 300 may be implemented as the terminal device 104 in FIG. 1 or a part of it. The various operations described below in connection with the terminal device may be implemented by units 302 and 304 or other possible units of the electronic device 300.

In the example of FIG. 3A, the first determination unit 302 may be configured to determine beam pair quality indications of a plurality of downlink beam pairs, the beam pair quality indications representing the quality of service that can be offered by corresponding beam pairs. The plurality of beam pairs can comprise the matched beam pairs, the candidate beam pairs, and the activated beam pairs (or corresponding BPLs) in the downlink. As previously mentioned, the beam pair quality indications can comprise a plurality of BQI elements. The plurality of BQI elements includes at least degree of stability of the measurement metrics. In some embodiments, the plurality of beam pair quality indication elements may also include instantaneous values and/or long-term values of the measurement metrics.

In the example of FIG. 3A, the first transceiving unit 304 may be configured to perform necessary information transceiving with a base station. For example, the transceiving unit 304 may be configured to receive one or more reference signals in the downlink and/or transmit one or more reference signals in the uplink.

In some embodiments, the electronic device 300 may be further configured to select candidate beam pairs or activated beam pairs based on various criteria after obtaining beam pair quality indications of a plurality of beam pairs, in order to achieve the desired targets.

FIG. 3B illustrates an exemplary electronic device for a base station side in accordance with an embodiment of the present disclosure, where the base station can be used for various wireless communication systems. The electronic device 350 shown in FIG. 3B can include various units to implement various embodiments according to the present disclosure. In this example, the electronic device 350 can comprise a second determination unit 352 and a second transceiving unit 354. In different implementations, the electronic device 350 may be implemented as the base station 100 in FIG. 1 or a part of it, or may be implemented as a device for controlling the base station 100 or otherwise related to the base station 100 (for example, a base station controller) or a part of such device. Various operations described below in connection with the base station can be implemented by units 352 and 354 or other possible units of the electronic device 350.

In the example of FIG. 3B, the second determination unit 352 may be configured to determine beam pair quality indications of a plurality of uplink beam pairs, the beam pair quality indications representing the quality of service that can be offered by corresponding beam pairs. The plurality of beam pairs can comprise the matched beam pairs, the candidate beam pairs, and the activated beam pairs (or corresponding BPLs) in the uplink. As previously mentioned, the beam pair quality indications can comprise a plurality of BQI elements. The plurality of BQI elements includes at least degree of stability of the measurement metrics. In some embodiments, the plurality of beam pair quality indication elements may also include instantaneous values and/or long-term values of the measurement metrics.

In the example of FIG. 3B, the second transceiving unit 354 may be configured to perform necessary information transceiving with a terminal device. For example, the second transceiving unit 354 may be configured to receive one or more reference signals in the uplink and/or transmit one or more reference signals in the downlink.

In some embodiments, the electronic device 350 may be further configured to select candidate beam pairs or activated beam pairs based on various criteria after obtaining beam pair quality indications of a plurality of beam pairs, in order to achieve the desired targets.

In some embodiments, the electronic devices 300 and 350 may be implemented at the chip level, or may also be implemented at the device level by including other external components. For example, each electronic device can work as a communication device as a whole machine.

It should be noted that the above various units are only logical modules divided according to the specific functions they implement, and are not intended to limit specific implementations, for example, they can be implemented in software, hardware, or a combination of software and hardware. In actual implementation, the above various units may be implemented as independent physical entities, or may be implemented by a single entity (for example, a processor (CPU or DSP, etc.), an integrated circuit, or the like). Wherein, the processing circuitry may refer to various implementations of a digital circuitry, an analog circuitry, or a mixed signal (combination of analog and digital) circuitry that perform functions in a computing system. The processing circuitry can comprise, for example, a circuit such as an integrated circuit (IC), an application specific integrated circuit (ASIC), a portion or circuit of a separate processor core, the entire processor core, a separate processor, a programmable hardware device such as a field programmable gate array (FPGA), and/or a system including multiple processors.

The exemplary electronic device and operations performed in accordance with an embodiment of the present disclosure are briefly described above with reference to FIGS. 3A and 3B. These and other operations will be described in detail below.

### Measurement Metrics Acquisition

In the disclosed embodiment, the plurality of BQI elements of the beam pair quality indication are obtained based on metrics measured from beam pairs (or corresponding BPLs). As mentioned earlier, the measurement metrics can be any measurement result on the performance of a beam pair, such as the received signal power, quality, signal-to-interference and noise ratio, and signal-to-noise ratio. The measurement metrics of a beam pair can be obtained by measuring (or referred to as receiving) the reference signal and/or data transmitted through the beam pair. The measurement metrics for the reference signal can comprise, but are not limited to, a reference signal received power, RSRP, a reference signal received quality, RSRQ, and a signal-to-interference and noise ratio, SINR. The measurement metrics for the data can comprise, but are not limited to, SINR and SNR.

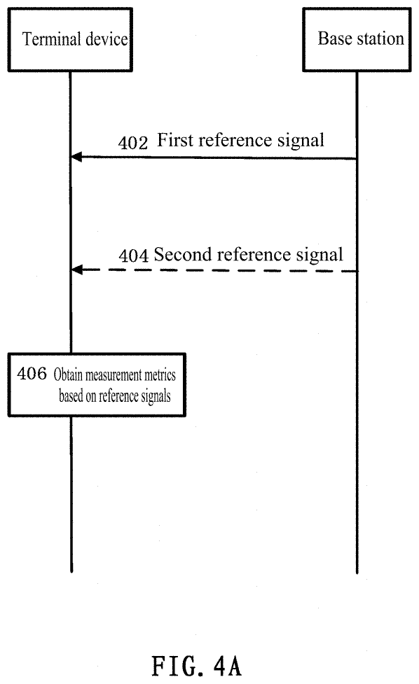

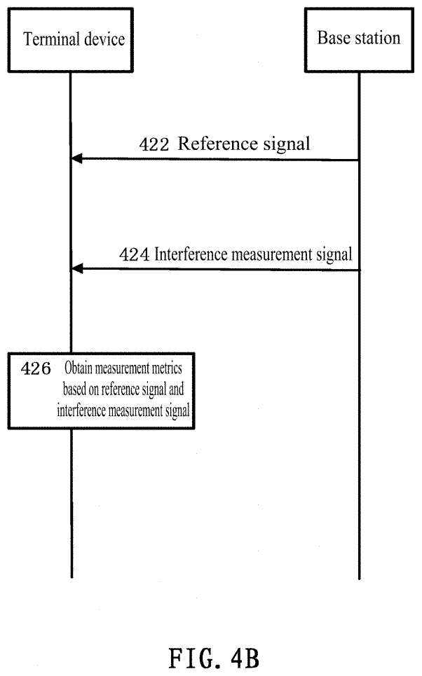

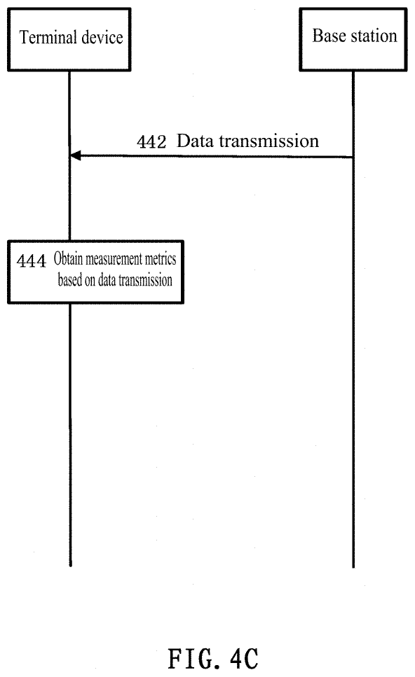

In the embodiments of the present disclosure, the reference signal may be any known reference signal (for example, any reference signal in LTE, NR system), and may be any reference signal that might come into exist later. Generally, a reference signal in the downlink can comprise, but are not limited to, a demodulation reference signal DMRS (including DMRS accompanying the downlink shared channel and the downlink control channel), a PTRS accompanying the downlink shared channel, a reference signal CSI-RS for downlink channel state estimation, a synchronization signal and a physical broadcast control channel SS/PBCH and a tracing reference signal TRS. A reference signal in the uplink can comprise, but are not limited to, a demodulation reference signal DMRS (including DMRS accompanying the uplink shared channel and the uplink control channel), a PTRS accompanying the uplink shared channel, and a sounding reference signal SRS for uplink channel state estimation. Exemplary processes for obtaining measurement metrics in accordance with embodiments of the present disclosure will be described below with reference to FIGS. 4A to 4C.

FIG. 4A illustrates an exemplary process of obtaining a measurement metrics of a downlink beam pair according to the present disclosure. The beam pair here may be a matched beam pair or a candidate beam pair. As shown in FIG. 4A, at 402, a base station (for example, electronic device 350, specifically, for example, the second transceiver unit 354) transmits a first downlink reference signal through one beam pair or corresponding BPL. At 406, a terminal device (for example, the electronic device 300, specifically, for example, the first transceiver unit 304) measures the downlink reference signal, thereby obtaining the measurement metrics of the beam pair or BPL. Here, the measurement metrics may be at least one of RSRP or RSRQ.

In one embodiment, at 404, the base station may optionally transmit a second downlink reference signal through the same beam pair or BPL, the second reference signal and the first reference signal are Quasi-colocation (QCL). At this time, the terminal device can measure this second reference signal to obtain the measurement metrics. Both measurement metrics obtained through the first and second reference signals can be used to represent the performance of the downlink beam pair or BPL. In an embodiment of the present disclosure, BQI elements may be obtained by processing measurement metrics of different types of reference signals (for example the first and second reference signals here, such as SS/PBCH and CSI-RS) which are quasi-colocation. In this way, a certain number of instantaneous values of the measurement metrics can be obtained in a shorter time period, or more instantaneous values of the measurement metrics can be obtained in the same time period. This may enable BQI elements to be obtained with more samples, or may reduce the latency in obtaining BQI elements.

Those skilled in the art should understand that there is a process corresponding to FIG. 4A to obtain the measurement metrics of the uplink BPL. For example, a terminal device (for example, the electronic device 300, specifically, for example, the first transceiving unit 304) transmits a first uplink reference signal or a quasi-colocated second reference (for example a quasi-colocated SRS and DMRS) through one beam pair (matched or candidate) or corresponding BPL. A base station (for example, the electronic device 350, specifically, for example, the second transceiver unit 354) measures the uplink reference signal to obtain the measurement metrics of the beam pair or BPL.

FIG. 4B illustrates another exemplary process of obtaining a measurement metrics of a downlink beam pair in accordance with an embodiment of the present disclosure. The beam pair here may be a matched beam pair or a candidate beam pair. As shown in FIG. 4B, at 422, a base station (for example, the electronic device 350, specifically, for example, the second transceiving unit 354) transmits a downlink reference signal through one beam pair or corresponding BPL. At 424, the base station transmits a downlink interference measurement signal through the same beam pair or corresponding BPL. Here, the reference signal and the interference measurement signal are in quasi-colocation. At 426, a terminal device (for example, the electronic device 300, specifically, for example, the first transceiver unit 304) measures the quasi-colocated reference signal and the interference measurement signal, thereby obtaining the measurement metrics of the beam pair or BPL. Here, the measurement metrics may be SINR, SNR, or any other appropriate metrics.

Those skilled in the art should understand that there may be a process corresponding to FIG. 4B to obtain the measurement metrics of the uplink beam pair. For example, a terminal device (for example, the electronic device 300, specifically, for example, the first transceiving unit 304) transmits a quasi-colocated uplink reference signal and a interference measurement signal through one beam pair or corresponding BPL (matched or candidate), respectively. A base station (for example, the electronic device 350, specifically, for example, the second transceiver unit 354) measures these uplink signals to obtain the measurement metrics of the beam pair or BPL.

The concept of quasi-colocation is explained here. In the embodiments of the present disclosure, if two signals experience the same channel condition (for example, the same spatial large-scale fading), the two signals may be referred to as being quasi-colocation. In one embodiment, a base station may configure multiple signals in the uplink or downlink (for example above-mentioned different reference signals, or reference signals and interference measurement signals, etc.) to be quasi-colocation through high-layer signaling (for example RRC layer signaling). Here, the example of configuration the quasi-colocation signal is described by taking the downlink DMRS and CSI-RS as examples. Referring back to FIGS. 2A and 2B, the transmitting beam 102 (4) of the BPL 130 may correspond to the antenna ports 150 (1) to 150 (3), and each antenna port may in turn correspond to one or more sets of resources. If a resource for transmitting a signal is specified, the transmitting beam and corresponding BPL for transmitting the signal can be determined based on the correspondence described above. Therefore, the same resources can be allocated for DMRS and CSI-RS, so that they can be transmitted through the same BPL, that is, they are quasi-colocation. In one example, the configuration of quasi-colocation can be signaled through downlink control information (for example, DCI, Downlink Control Information).

In FIG. 4B, the terminal device may obtain the BPL measurement metrics through the downlink interference measurement signal. One application example of FIG. 4B is described here with reference to the NR system. In the NR system, the exemplary reference signal of the downlink includes CSI-RS, and the exemplary interference measurement signal includes CSI-IM, both of which are associated with the same CSI process. CSI-RS and CSI-IM can be configured to be quasi-colocated through high-level signaling (for example RRC signaling) to control their transmission. For example, on the CSI-RS frequency resource (for example, as shown in FIG. 2B), a non-zero power CSI-RS (i.e., NZP-CSI-RS) may transmit by a base station through a beam pair at the first time instant and the received power P1 is obtained by a terminal device; at the second time instant, a zero-power CSI-IM (i.e., ZP-CSI-RS) is transmitted by the base station through the same beam pair and the received power P2 is obtained by the terminal device. Since the power of the reference signal transmitted at the second time instant is zero, P2 can be regarded as the power of interference and/or noise, and then the SINR (or SNR) of the beam pair can be roughly expressed as P2/P1.

FIG. 4C illustrates still another example process of obtaining the measurement metrics of the downlink beam pair according to the present disclosure. The beam pair here may be an activated beam pair. As shown in FIG. 4C, at 442, a base station (for example, the electronic device 350, specifically, for example, the second transceiver unit 354) transmits downlink data through one beam pair or a corresponding BPL. At 444, a terminal device (for example, the electronic device 300, specifically, for example, the first transceiver unit 304) receives the downlink data, thereby obtaining the measurement metrics of the beam pair or BPL. Here, the measurement metrics may be SINR, SNR, or any other appropriate metrics.

Those skilled in the art should understand that there is a process corresponding to FIG. 4C to obtain the measurement metrics of the uplink BPL. For example, a terminal device (for example, the electronic device 300, specifically, for example, the first transceiving unit 304) transmits uplink data through one beam pair or corresponding BPL (activated). A base station (for example, the electronic device 350, specifically, for example, the second transceiver unit 354) receives the uplink data, thereby obtaining the measurement metrics of the beam pair or BPL.

It can be understood that, in the case that the uplink and downlink time division multiplexing or uplink and downlink beam pairs substantially meet reciprocity, only the measurement metrics of the downlink can be obtained to so as to estimate uplink measurement metrics of the uplink, or, only the measurement metrics of the uplink can be obtained so as to estimate measurement metrics of the downlink.

### Beam Pair Quality Indication (BQI)/BQI Element Acquisition

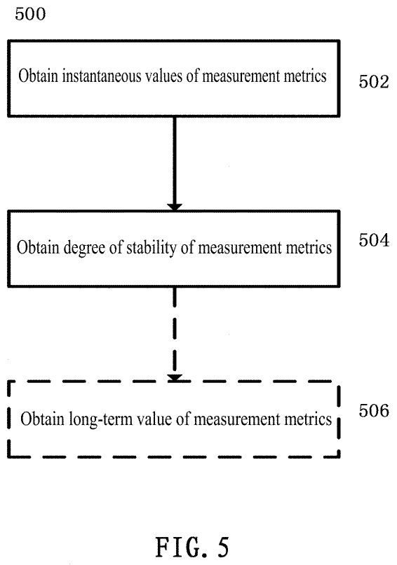

Obtaining the measurement metrics of the beam pair by, for example, the operations shown in FIGS. 4A to 4C, can, in fact, obtain instantaneous values of a plurality of measurement metrics of the beam pair. The instantaneous values characterize the performance of the corresponding beam pair or the instantaneous state of the quality of service it can offer. The degree of stability and/or the long-term value of the measurement metrics of the beam pair can be obtained by processing multiple instantaneous values, as described below with reference to FIG. 5.

FIG. 5 illustrates an exemplary operation of obtaining each BQI element of a beam pair quality indication in accordance with an embodiment of the present disclosure. As shown in FIG. 5, for one beam pair or corresponding BPL, at 502, a terminal device/base station can obtain instantaneous values of the downlink/uplink measurement metrics. After multiple measurements, a plurality of instantaneous values of the measurement metrics of the beam pair can be obtained. At 504, the terminal device/base station can process the plurality of instantaneous values of the measurement metrics, thereby obtaining degree of stability of the measurement metrics. In an embodiment, the degree of stability may be any suitable measuring standard that reflects the degree of fluctuation or deviation of the measurement metrics. For example, the degree of stability may be the variance of a plurality of instantaneous values of the measurement metrics or a variation thereof (for example, standard deviation, and sample variance). Alternatively or additionally, at 506, the terminal device/base station may process the plurality of instantaneous values of the measurement metrics, thereby obtaining a long-term value of the measurement metrics. In an embodiment, the long-term value may be an average value or weighted average value of a plurality of instantaneous values of the measurement metrics. In an embodiment, the plurality of instantaneous values of the measurement metrics may come from the measurement on the same signal or a plurality of signals which are quasi-colocation.

One calculation example of each BQI element of the downlink beam pair quality indication is described below. Taking the downlink as an example, let Hₜ∈ [symbol] ^{N×M} to be the downlink channel matrix between a base station and a terminal device at time instant t (where k≥0, and is an integer), and let b∈ [symbol] ^{M×1} and w∈ [symbol] ^{N×1} to be the beamforming vector on the base station side and the merge vector on the terminal device side, respectively, where M and N are the number of antennas on the base station side and the terminal device side, respectively. The terminal device measures the downlink reference signal at time instant t and obtains the instantaneous value of RSRP, denoted as Qₜ,

Qₜ=|w^{T}Hₜb|² (Equation 1)

The degree of stability and long-term value of the measurement metrics in the BQI element are calculated as follows. The variance of a RSRP is calculated to obtain the degree of stability of the RSRP, and the variance of the RSRP from time instant t=0 to time instant t=t₀ is denoted as σₜ_{₀}², which can be expressed as:

$${σ}_{{t}_{0}}^{2} = Var \{ {Q}_{0} , … , {Q}_{{t}_{0}} \} = \frac{1}{{t}_{0}} {\sum }_{t = 0}^{{t}_{0}} {Q}_{t}^{2} - {\overline{Q}}_{{t}_{0}}^{2} \qquad ( Equation 2 )$$

where Q̅ₜ_{₀} is the average value of the RSRP from time instant t=0 to time instant t=t₀.

The process of calculating the average value of a RSRP also obtained the long-term value of the RSRP. The average value of the RSRP from time instant t=0 to time instant t=t₀ is denoted as Q̅ₜ_{₀}, which can be expressed as:

$${\overline{Q}}_{{t}_{0}} = \frac{1}{{t}_{0}} {\sum }_{t = 0}^{{t}_{0}} {Q}_{t} \qquad ( Equation 3 )$$

For the long-term value of the RSRP, the starting time instant can also be adjusted from t=0 to t=tₛ, then the average value of the RSRP can be expressed as:

$${\overline{Q}}_{{t}_{s} , {t}_{0}} = \frac{1}{{t}_{0} - {t}_{s}} {\sum }_{t = {t}_{s}}^{{t}_{0}} {Q}_{t} \qquad ( Equation 4 )$$

In one embodiment, in order to save storage space, it is not necessary to store all instantaneous RSRP measurement results from time instant t=0 to time instant t=t₀. At this time, the sequential calculation method can be adapted, where the average value Q̅ₜ_{₀} and variance σₜ_{₀}² of the RSRP at time instant t=t₀ are known, and the instantaneous RSRP at time instant t=t₀+1 is obtained via measurement, then the average value Q̅ₜ_{₀}₊₁ and variance σₜ_{₀}₊₁² of RSRP at the time instant t=t₀+1 can be updated as:

$$\begin{matrix} {\overline{Q}}_{{t}_{0} + 1} = \frac{1}{{t}_{0} + 1} {\sum }_{t = 0}^{{t}_{0} + 1} {Q}_{t} = \frac{{t}_{0} {\overline{Q}}_{{t}_{0}} + {\overline{Q}}_{{t}_{0} + 1}}{{t}_{0} + 1} & ( Equation 5 ) \\ \begin{matrix}{σ}_{{t}_{0} + 1}^{2} = \frac{1}{{t}_{0} + 1} {\sum }_{t = 0}^{{t}_{0} + 1} {Q}_{t}^{2} - {\overline{Q}}_{{t}_{0} + 1}^{2} \\ = \frac{{t}_{0} ( {σ}_{{t}_{0}}^{2} + {\overline{Q}}_{{t}_{0}}^{2} ) + {Q}_{{t}_{0} + 1}^{2}}{{t}_{0} + 1} - {\overline{Q}}_{{t}_{0} + 1}^{2}\end{matrix} & ( Equation 6 )\end{matrix}$$

In the embodiments of the present disclosure, a terminal device may measure instantaneous values of the measurement metrics periodically to calculate the long-term value Q̅ₜ_{₀} and the degree of stability σₜ_{₀}². Generally speaking, a larger Q̅ₜ_{₀} indicates that the beam pair link can provide a higher average beamforming gain over a period of time; a smaller σₜ_{₀}² indicates that the beam pair link can provide a more stable data service.

### Beam Pair/BPL Evaluation and Selection

In the embodiments of the present disclosure, a beam pair quality indication includes at least degree of stability of the measurement metrics, and thus can better characterize degree of stability of the beamforming gain of the corresponding beam pair or BPL, that is, the stability when providing communication services. When selecting a candidate beam pair and a activated beam pair for a communication service, if a beam pair with high stability can be selected, the possibility of frequently switching the BPL during communication can be reduced. Therefore, the beam pair quality indication in accordance with an embodiment of the present disclosure can facilitate selection of a BPL with high stability for communication services, thereby preventing frequent BPL switching. In the embodiments of the present disclosure, the beam pair quality indication may also include instantaneous values and long-term values of measurement metrics, which represent respectively the magnitude of the beamforming gain of the corresponding beam pair or BPL, and the magnitude of the beamforming gain can be proportional to the transmission capability (i.e. the magnitude of data rate) that the beam pair can offer. Therefore, the activated BPL can also be selected based on the instantaneous value and long-term value of the measurement metrics to ensure the data rate requirements for the communication service.

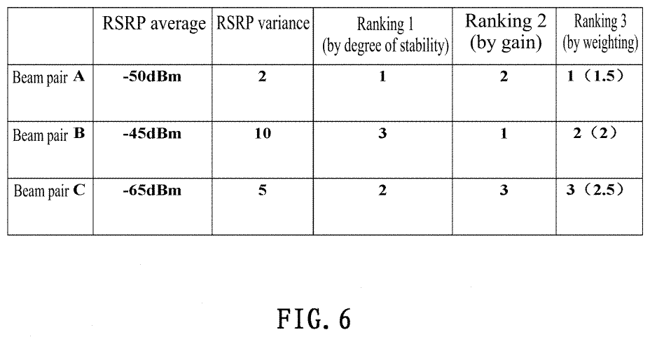

In some embodiments, the activated and/or candidate beam pair or BPL can be selected based on the beam pair quality indication of the beam pair or BPL. For example, beam pairs may be ranked based on beam pair quality indications. In one embodiment, beam pairs may be ranked based on a single BQI element of interest, or the beam pairs may be ranked based on a plurality of BQI elements of interest, so that the beam pairs are selected based on the ranking. FIG. 6 illustrates an example of ranking beam pairs in accordance with an embodiment of the present disclosure. As shown in FIG. 6, the average values of RSRP of the beam pairs A, B, and C are −50 dBm, −45 dBm, and −60 dBm, respectively, and their RSRP variances are 2, 10, and 5, respectively. If the BQI element of interest is degree of stability of the measurement metrics, the beam pairs ranking 1 is beam pair A, beam pair C, and beam pair B. If the BQI element of interest is the long-term value of the measurement metrics, the beam pairs ranking 2 is beam pair B, beam pair A, and beam pair C. If both the degree of stability and the long-term value of the measurement metrics are BQI elements of interest, then these two elements can be weighted, for example, to determine the beam pairs ranking. Assuming that the weighted values for both the degree of stability and the long-term value of the measurement metrics are 0.5, and by weighting on ranking 1 and ranking 2, the beam pairs ranking 3 is beam pair A, beam pair B, and beam pair C. It can be understood that when beam pair selection is performed based on ranking 1, the beam pair with a high degree of stability is preferentially used, thereby improving the stability of the beam pairs and reducing the possibility of BPL switching. When beam pair selection is performed based on ranking 2, the beam pair with large beamforming gains is preferentially used, thereby improving the transmission capability of the beam pairs and ensuring the data rate of communication services. It can be understood that ranking 3 can take a compromise between stability and data transmission capability.

### Matching of Beam Pair/BPL and Communication Service

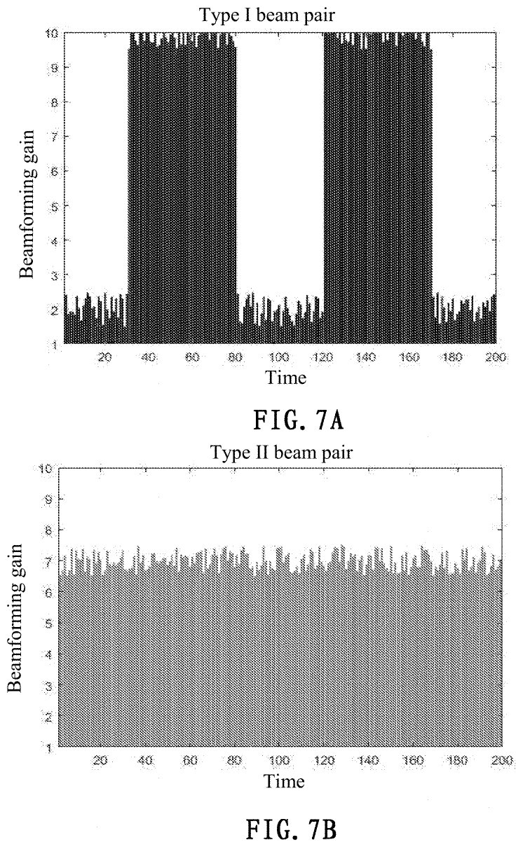

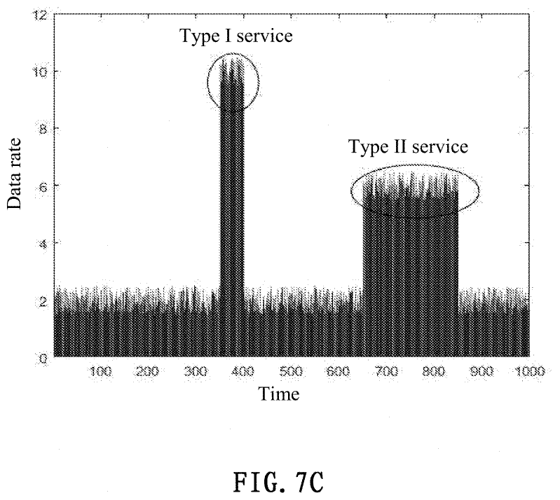

A person skilled in the art may use beam pair quality indications according to the present disclosure in any suitable manner, for example, the beam pair or BPL beam pair quality indication may be matched with the quality of service for communication service. An example scenario where the beam pair or beam pair quality indication of the BPL matches the quality of service for communication service is described below with reference to FIGS. 7A to 7B. FIGS. 7A and 7B illustrate two types of beam pairs. Among them, larger instantaneous values of the beamforming gain exists in the type I beam pairs, and the instantaneous values of the beamforming gain in the type II beam pairs are relatively smaller. The long-term values of the beamforming gain of these two beam pairs may be equivalent, but the degree of stability of the beamforming gain of the type I beam pairs is less than that of the type II beam pairs. FIG. 7C illustrates two types of communication services. Among them, the type I service is bursty and the data rate during the burst is high, and the type II service has a lower data rate and a longer duration and is relatively stable. Qualitatively, type I beam pairs may be more suitable for type I communication services, and type II beam pairs may be more suitable for type II communication services. Therefore, it may be beneficial to match beam pairs or BPL beam pair quality indications with the quality of service for communication services.

Generally speaking, the quality of service requirements for communication can comprise a plurality of quality of service targets. From a data rate perspective, quality of service targets can comprise instantaneous data rate target, average data rate target, and data rate fluctuation degree target. Wherein, the data rate fluctuation degree target represents a tolerable data rate jitter. For example, if the data rate jitter exceeds the fluctuation degree target, it will cause a large latency to the communication service, thereby failing to meet the quality of service requirement.

In an embodiment of the present disclosure, the target related to the data rate may correspond to a BQI element of a beam pair. One example of this correspondence is shown in the following table, where the instantaneous data rate target, average data rate target, and data rate fluctuation degree target can correspond to the instantaneous value, long-term value, and degree of stability of the measurement metrics, respectively. Here, the measurement metrics may be RSRP, RSRQ, SINR or SNR or any appropriate measurement metrics. Based on the correspondence, the beam pair can be selected so that the BQI elements of the beam pair match the quality of service target for communication service. In one embodiment, the data rate target can be converted to the demand for the measurement metrics, for example, the instantaneous data rate A can be converted to the average value A1 of the measurement metrics RSRP, and the average data rate B can be converted to the average value B1 of the measurement metrics RSRP, and the data rate fluctuation degree target C can be converted into the variance C1 of the measurement metrics RSRP. When determining whether the specific BQI element matches the data rate targets, it is necessary to determine whether the actual BQI elements meet the corresponding values after the conversion above, for example, A1, B1, and C1.

TABLE
Data rate targets corresponding to BQI elements

| Data rate targets | BQI elements |
|---|---|
| Instantaneous | Instantaneous value |
| data rate target | of measurement metrics |
| Average data | Long term value of |
| rate target | the measurement metrics |
| Data rate fluctuation | Degree of stability |
| degree target | of measurement metrics |

In some embodiments, the activated beam pair or BPL that matches the communication service may be selected based on the beam pair quality indication. In one embodiment, such matching can comprise matching at least one BQI element of the activated beam pair with the corresponding quality of service target for communication. In one embodiment, such matching can comprise, there is a BQI element for the activated beam pair, to match at least with a quality of service target with a highest priority for the communication. These embodiments and the examples described below are also applicable to candidate beam pairs. If all candidate beam pairs can be matched with the communication service, then since the activated beam pair is generally selected from the candidate beam pairs, the activated beam pair can also be matched with the communication service.

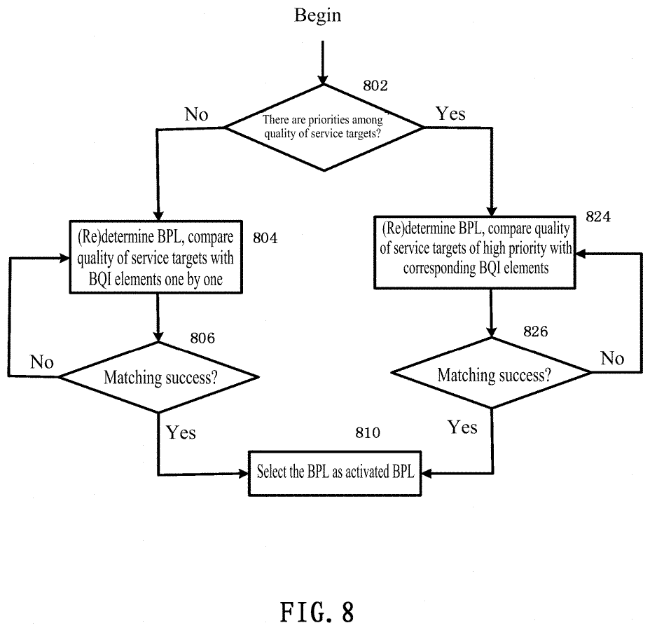

FIG. 8 illustrates one example process of matching a beam pair (or BPL) with a communication service in accordance with an embodiment of the present disclosure. As shown in FIG. 8, first at 802, it is determined whether there are priorities among a plurality of quality of service targets of the communication service. If there is no priority among the plurality of quality of service targets, then proceed to 804. At 804, for a determined beam pair (or BPL), the plurality of quality of service targets can be compared with BQI elements of the beam pair one by one. At 806, it is determined whether each quality of service target matches the corresponding BQI element of the beam pair. If they all match, the match is successful and proceeds to 810. At 810, the determined beam pair is selected as the activated beam pair. At 806, if there is a mismatched quality of service target, the match is unsuccessful and returns to 804. At 804, for a re-determined beam pair, the plurality of quality of service targets can be compared with the BQI elements of the re-determined beam pair one by one, and it is determined similarly whether the match is successful. Through the loop operations in 804 and 806, it is possible to determine whether the quality of service targets match with the BQI elements on a beam-pair-by-beam-pair basis, until the activated beam pair is selected. Of course, it is also possible that the activated beam pair cannot be selected even after performing this operation for each beam pair. At this time, the terminal device needs to negotiate with the base station or the base station adjusts the matching criteria, as described below.

Returning to 802, at 802, if it is determined that there are priorities among the plurality of quality of service targets of the communication service, then proceed to 824. At 824, for a determined beam pair, quality of service targets with high priority can be compared with the corresponding BQI elements of the beam pair. In one embodiment, priorities of the quality of service targets are predefined by the system according to service types. In another embodiment, priorities of the quality of service targets are determined by a base station or negotiated by a terminal device with a base station. At 806, it is determined whether quality of service targets with high priority matches the corresponding BQI elements of the beam pair. If matches, the match is successful and proceeds to 810. At 810, the determined beam pair is selected as the activated beam pair. At 826, if quality of service targets with high priority does not match the corresponding BQI elements of the beam pair, the match is unsuccessful and returns to 824. At 824, for a re-determined beam pair, quality of service targets with high priority can be compared with the corresponding BQI elements of the re-determined beam pair, and it is determined similarly whether the match is successful. Through the loop operations in 824 and 826, it is possible to determine whether quality of service targets with high priority match with the beam pair on a beam-pair-by-beam-pair basis, until the activated beam pair is selected. Of course, it is also possible that the activated beam pair cannot be selected even after performing this operation for each beam pair. At this time, the terminal device needs to negotiate with the base station or the base station adjusts the matching criteria or priorities of the quality of service metrics.

As described above, in 804 or 824, the beam pair or BPL may be determined one by one to determine whether its BQI elements match the quality of service targets. In one embodiment, there may be an order in which beam pairs are determined one by one. For example, if better beam pair stability is desired, the beam pairs can be determined one by one in order of degree of stability of the measurement metrics from high to low (for example, with the variance from small to large) for comparison and matching. If better beamforming gain is desired, the beam pairs can be determined one by one in order of the long-term value (and/or instantaneous value) of the measurement metrics from high to low (for example, with the average value from large to small) for comparison and matching.

One example of the matching operation in 806 is described here. Assume that the instantaneous data rate target of the service is converted to the required RSRP instantaneous value Q_{UE}, the long-term data rate target of the service is converted to the required RSRP long-term value Q̅_{UE}, and the tolerable data rate fluctuation target of the service is converted to the required degree of stability of RSRP σ_{UE}², the selected activated beam pair should meet to conditions:

Q_{(i,j)}≥Q_{UE} (Equation 7)

Q̅_{(i,j)}≥Q̅_{UE} (Equation 8)

σ_{i,j}²≤σ_{UE}² (Equation 9)

Wherein, Q_{(i,j)}, Q̅_{(i,j)} and σ_{i,j}² are BQI elements of the beam pair {bᵢ, wⱼ} formed with the transmitting beam i and the receiving beam j respectively, that is, instantaneous RSRP, long-term average RSRP and RSRP variance. In 806, it is determined that the match is successful only when all of above formulas are met. While for the operation in 826, only quality of service targets with high priority are needed to meet the corresponding formula. For example, for type I services, Q_{UE} is of the highest priority and should be met first; for type II services, σ_{UE}² is of the highest priority and should be met first.

According to an embodiment of the present disclosure, the example matching operations in FIG. 8 may enable the selected activated beam pair to meet the quality of service requirements for the communication. Generally speaking, the matching here can comprise any degree of matching that can meet the quality of service requirements. For example, the matching could be that the quality of the selected activated beam pair far exceeds the quality of service requirements for the communication service, or the quality of the selected activated beam pair just meets or substantially meets the quality of service requirements for the communication service. According to the embodiments of the present disclosure, the above-mentioned matching degree can be controlled, so that on the one hand, it can meet the communication needs of a single terminal device, on the other hand, it can optimize the utilization of system resources (for example, by making the quality of the beam pair just meet the requirements for the communication service, so that it is possible to match beam pairs with better quality with other services with higher requirements), so as to serve more terminal devices with the limited resources of the base station.

The following table shows exemplary quality of service requirements for communication services. In one embodiment, it can be considered that real-time games and Internet of Vehicles V2X services have medium instantaneous and average data flow targets, and higher data rate fluctuation degree target. In one embodiment, it can be considered that the URLLC service has lower instantaneous and average data flow targets and higher data rate fluctuation degree target. In FIG. 6, it would be beneficial for the above-mentioned services to select beam pairs according to degree of stability of the measurement metrics; or it would be beneficial for this type of services to assign higher priority to the data rate fluctuation degree target of the above-mentioned services so as to preferentially match the degree of stability in the BQI element.

In one embodiment, it can be considered that non-conversational video services have higher instantaneous and average data flow targets and lower data rate fluctuation degree targets. In FIG. 6, it would be beneficial for such services to select beams pairs in accordance with beamforming gains; or it may be beneficial for such services to assign higher priority to the average and/or instantaneous data rate targets for such services so as to preferentially match the long-term and/or instantaneous values in the BQI element.

TABLE
Quality of Service Requirements for Exemplary Services

| | Instantaneous | Average | Data rate |
|---|---|---|---|
| | data rate | data rate | fluctuation |
| Service example | target | target | degree target |
| Real-time games | Medium | Medium | High |
| Internet of Vehicles V2X | | | |
| URLLC | Low | Low | High |
| Non-conversational video | High | High | Low |

### Exemplary Implementation

The long-term value of the measurement metrics in beam pair quality indications can be regarded as the first moment in the time domain of the instantaneous values of the measurement metrics. Therefore, in one embodiment, the long-term value of the measurement metrics can be obtained through time-domain filtering. One exemplary implementation of time-domain filtering is using a time-domain Finite Impulse Response (FIR) filter.

It is assumed that the coefficient vector of the FIR filter is β=[β₁, . . . , β_{T}]^{T}∈ [symbol] ^{T×1}, whose input vector is a vector of a plurality of instantaneous values of a measurement metrics (such as RSRP), which is denoted as Qᵢₙ=[Q₁, . . . , Q_{T}]^{T}∈ [symbol] ^{T×1}, where T is the length of the FIR filter. Then the output value of the FIR filter is the long-term value of RSRP, which is denoted as Qₒᵤₜ=Σₜ₌₁^{T}βₜQₜ=β^{T}Qᵢₙ. Wherein the FIR coefficient vector β should meet the constraints ∥β∥₁=1, βₜ≥0, 1≤t≤T. The coefficient vector β can be regarded as a weighted average of the input vectors Qᵢₙ of instantaneous values of RSRP. By adjusting the value of each element of the coefficient vector, long-term values can be obtained with different emphasis (for example, assigning greater weight to the most recent instantaneous value). In particular, select

$$β = \frac{1}{T} 1 ,$$

then the long-term value of RSRP derived is an average value. In conjunction with time-domain filtering, a shift register can be designed, which stores the input vector Qᵢₙ of instantaneous values of the most recent measurement metrics so as to perform time-domain filtering on it.

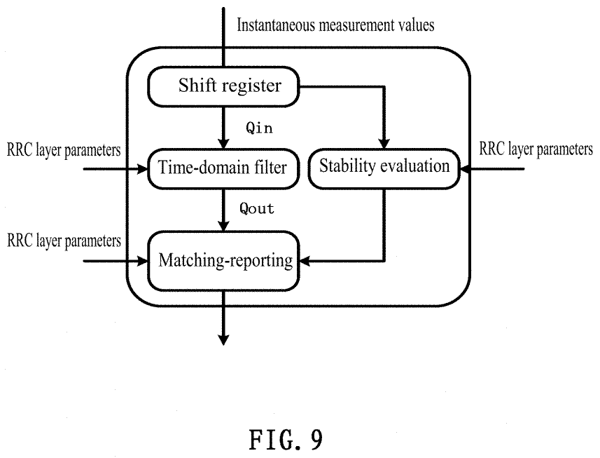

FIG. 9 illustrates example operations of processing measurement metrics in accordance with an embodiment of the present disclosure. As shown in FIG. 9, instantaneous measurement values (for example, instantaneous values of the measurement metrics of the physical layer) may be stored in the shift register. For example, the most recent T (i.e., time-domain filter length) instantaneous measurement values can be stored in this shift register. Next, the most recent T instantaneous measurement values form a vector Qᵢₙ as input to the time-domain filter. The output of the time-domain filter Qₒᵤₜ is the long-term value of the measurement metrics. In parallel with time-domain filtering, the degree of stability of the measurement metrics can be obtained based on the most recent T instantaneous measurement values. The degree of stability of the measurement metrics can be obtained in consideration of various fluctuation measurement metrics, including but not limited to variance, standard deviation, and sample variance. After obtaining the long-term value and the degree of stability of the measurement metrics, based on the obtained BQI elements, the communication service can be matched with the beam pairs (applicable to both the base station and the terminal device), or the BQI can be reported to the base station (applicable to the terminal device).

In some embodiments, the operation of obtaining the long-term value/degree of stability of the measurement metrics and the operation of matching the beam pairs with the communication service can be controlled by higher layer signaling (for example, RRC layer signaling). In the example of FIG. 9, time-domain filtering, stability evaluation, and matching/reporting operations can all be controlled by RRC layer parameters. Through the RRC layer parameters, for example, it is possible to control the filtering parameters, whether to enable stability evaluation or time-domain filtering, specific quality of service targets, and the priorities among these targets.

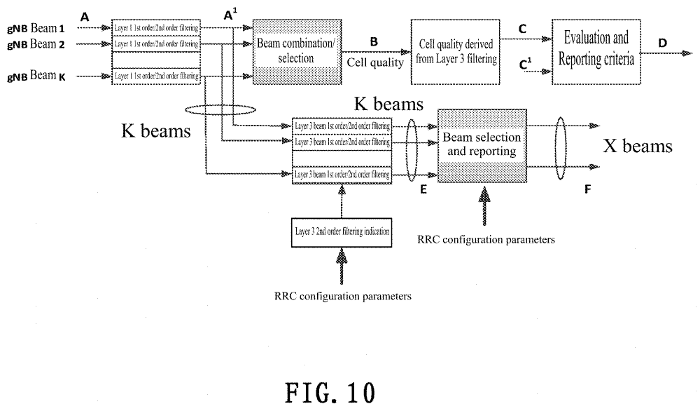

An exemplary application of beam pair quality indication in an NR system in accordance with an embodiment of the present disclosure is described below with reference to FIG. 10.

FIG. 10 illustrates an exemplary measurement model in the NR system. At point A, perform physical layer measurements on gNB beams 1 to K, and perform first order and/or second order filtering in Layer 1 (to obtain long-term value and/or degree of stability of the measurement metrics) for the measurement metrics, thereby obtaining beam pair quality indications of K beams at point A¹. In FIG. 10, through the upper path, the cell quality can be obtained based on the beam pair quality indications of the K beams for evaluation and reporting. Through the lower path, X beams can be selected based on the beam pair quality indications of the K beams for candidate or activated beam pairs. Optionally, through the control of RRC layer signaling, it is also possible to perform first order and/or second order filtering in Layer 3 (to obtain long-term value and/or degree of stability of measurement metrics) for the beam pair quality indications of the K beams, thereby obtaining filtered beam pair quality indications in the Layer 3 at point E. At this time, X beams can be selected based on the beam pair quality indications of the filtered K beams in Layer 3 for candidate or activated beam pairs. In FIG. 10, whether the first order and/or second order filtering in Layer 3 is needed, and the selection of specific filtering parameters (such as filter coefficient β, filter length T, and the form of second order filtering, etc.) can all be controlled by RRC layer signaling. In one embodiment, the selection criterion for X beams can also be controlled by RRC layer signaling. The selection criterion for beams can be any one or more of the aforementioned criteria of the present disclosure, for example, based on one or more BQI elements, or based on BQI elements matching with quality of services.

### Signaling Process Example

An exemplary signaling flow between a terminal device and a base station in accordance with an embodiment of the present disclosure is described here. For the downlink, after the terminal device obtains beam pair quality indications of downlink beam pairs through measurement, the beam pairs may be selected based on the beam pair quality indications, and the beam pairs can comprise activated beam pairs and candidate beam pairs. According to an embodiment of the present disclosure, the downlink beam pairs may be selected by the terminal device or the base station. In some embodiments, after obtaining the beam pair quality indications, the terminal device may transmit them to the base station, and the base station performs beam pairs selection. In some embodiments, after obtaining the beam pair quality indications, the terminal device may perform beam pairs selection itself.

For the uplink, after the base station obtains beam pair quality indications of uplink beam pairs through measurement, the activated beam pairs and the candidate beam pairs may be selected based on the beam pair quality indications. According to an embodiment of the present disclosure, the uplink beam pairs may be selected by the base station. In some embodiments, after obtaining the beam pair quality indications, the base station may perform beam pairs selection.

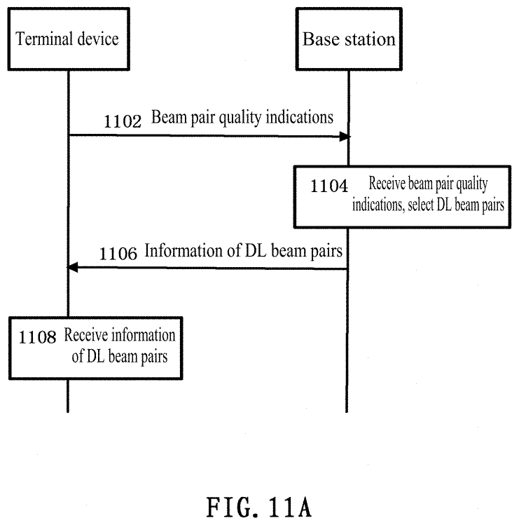

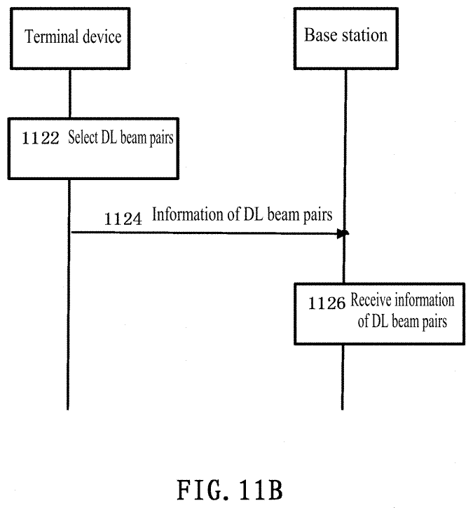

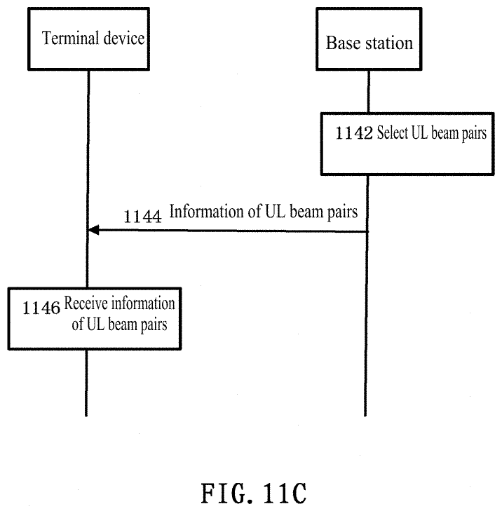

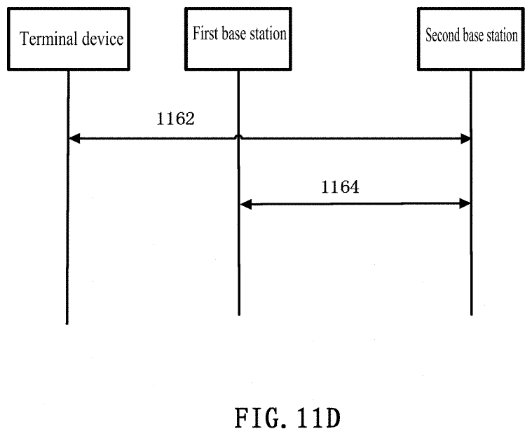

An example signaling flow for selecting a downlink beam pair in accordance with an embodiment of the present disclosure is described below with reference to FIGS. 11A and 11B. In an embodiment, the corresponding operations may be performed by the electronic device 300 on a terminal device side and the electronic device 350 on a base station side, respectively.

In FIG. 11A, after obtaining beam pair quality indications of one or more downlink beam pairs, the terminal device (for example, the electronic device 300, specifically, for example, the first transceiver unit 304) transmits to the base station (for example, the electronic device 350) beam pair quality indications, as shown in 1102. Here, the beam pair quality indications may be the beam pair quality indications of one or more beam pairs, and can comprise all or part of the BQI elements. In an embodiment, the terminal device may transmit beam pair quality indications of all beam pairs or a part of the beam pairs to the base station. For example, the terminal device only transmits the beam pair quality indications of a part of the beam pairs that are ranked higher, so as to select the candidate beam pairs or the activated beam pairs from this part of the beam pairs. For an example of ranking beam pairs, refer to FIG. 6, and beam pairs may be ranked according to degree of stability, gain, or weighting scheme, so as to determine the beam pairs that ranked higher. For another example, the terminal device only transmits the beam pair quality indications of the candidate beam pairs, so as to select the activated beam pairs from them. In an embodiment, the terminal device may transmit only a part of BQI elements. For example, this part of elements may be the elements on which the criteria for selecting beam pairs depend (for example, if the criterion for selecting beam pairs is the degree of stability, the element on which it depends is the degree of stability of the measurement metrics. Others can be deduced similarly). Between the terminal device and the base station, the criteria for selecting the beam pair can be negotiated through signaling (for example, RRC layer signaling) or directly indicate the BQI elements that need to be transmitted.

At 1104, the base station (for example, the second transceiving unit 354) receives beam pair quality indications of one or more downlink beam pairs from the terminal device, and selects one or more beam pairs from the downlink beam pairs. In an embodiment, the base station may select candidate beam pairs or activated beam pairs from a plurality of matched beam pairs, or may select activated beam pairs from a plurality of candidate beam pairs. The base station may select beam pairs based on various criteria, for example, beam pairs may be selected based on BQI elements (such as degree of stability, gain, or a combination thereof). For another example, the base station may select beam pairs based on the criteria that the BQI elements match with quality of service targets.

At 1106, the base station may transmit information of the selected beam pairs to the terminal device, the information including at least indexes of the one or more beam pairs. At 1108, the terminal device receives information of the one or more beam pairs from the base station. In one embodiment, through the signaling process, the base station can select candidate beam pairs or activated beam pairs from the matched downlink beam pairs, and the terminal device can track the performance of the candidate beam pairs or communicate using the activated beam pairs accordingly. Alternatively or additionally, the base station may select the activated beam pairs from the downlink candidate beam pairs, and accordingly, the terminal device may use the activated beam pairs for communication. In various embodiments, various desired performances can be achieved corresponding to various criteria for selecting beam pairs.

In FIG. 11B, after obtaining beam pair quality indications of one or more downlink beam pairs, a terminal device (for example, the electronic device 300) may select one or more beam pairs from a plurality of beam pairs, as shown in 1122. Similarly, in an embodiment, the terminal device may select candidate beam pairs or activated beam pairs from a plurality of matched beam pairs, or may select activated beam pairs from a plurality of candidate beam pairs. The terminal device may select beam pairs based on various criteria, for example, beam pairs may be selected based on BQI elements (such as degree of stability, gain, or a combination thereof). For another example, the base station may select beam pairs based on the criteria that the BQI elements match with quality of service targets.

At 1124, a terminal device (for example, the first transceiver unit 304) may transmit information of one or more beam pairs to a base station (for example, the electronic device 350), the information including at least indexes of the one or more activated beam pairs links. In an embodiment, the one or more beam pairs may be candidate beam pairs, or may be activated beam pairs.

At 1126, a base station (for example, the second transceiving unit 354) receives information of the one or more beam pairs from the terminal device. In one embodiment, through this signaling process, the terminal device can select candidate beam pairs or activated beam pairs from the matched downlink beam pairs, and then may track the performance of the candidate beam pairs or communicate using the activated beam pairs accordingly. Alternatively or additionally, the terminal device may select activated beam pairs from downlink candidate beam pairs, and then may use the activated beam pairs to communicate accordingly. In various embodiments, various desired performances can be achieved corresponding to various criteria for selecting beam pairs.

An exemplary signaling flow for selecting a downlink beam pair in accordance with an embodiment of the present disclosure is described below with reference to FIG. 11C. In an embodiment, corresponding operations may be performed by the electronic device 300 on a terminal device side and the electronic device 350 on a base station side, respectively.

In FIG. 11C, after obtaining beam pair quality indications of one or more uplink beam pairs, a base station (for example, the electronic device 350) may select one or more beam pairs from a plurality of beam pairs, as shown in 1142. In an embodiment, the base station may select candidate beam pairs or activated beam pairs from a plurality of matched beam pairs, or may select activated beam pairs from a plurality of candidate beam pairs. The terminal device may select beam pairs based on various criteria, for example, beam pairs may be selected based on BQI elements (such as degree of stability, gain, or a combination thereof). For another example, the base station may select beam pairs based on the criteria that the BQI elements match with quality of service targets.

At 1144, a base station (for example, the second transceiver unit 354) may transmit information of the one or more beam pairs to a terminal device (for example, the electronic device 300), the information including at least indexes of the one or more activated beam pairs links. At 1146, a terminal device (for example, the first transceiving unit 304) may receive information of the one or more beam pairs from the base station. In one embodiment, through the signaling process, the base station can select candidate beam pairs or activated beam pairs from the matched uplink beam pairs, and then can track the performance of the candidate beam pairs or communicate using the activated beam pairs accordingly. Alternatively or additionally, the base station may select the activated beam pairs from the uplink candidate beam pairs, and then may use the activated beam pairs for communication accordingly. In various embodiments, various desired performances can be achieved corresponding to various criteria for selecting beam pairs.

In some embodiments, information can be transferred between the terminal device and the base station by means of Dual Connectivity. Dual connectivity is a technology that enables terminal devices to communicate with a plurality of base stations, so as to increase data rate or reliability. For example, a terminal device may maintain a connection with both a first base station and a second base station. In the process of communication between the first base station and the terminal device, the second base station may be added to form a dual connectivity as desired (for example, a desire to increase the data rate or reliability), and then the first base station becomes the primary node and the second base station becomes the secondary node. In some cases, the master node may be an eNB (for example a Master eNB) in an LTE system, and the secondary base station may be a corresponding node in a 5G system, for example a gNB (for example a Secondary gNB) in an NR system. The opposite can also apply. In one embodiment, the first base station may not be limited to an eNB, and the second base station may not be limited to a gNB. For example, the first base station and the second base station may be any base stations belonging to the same wireless communication system or to different wireless communication systems.

FIG. 11D illustrates an example of a dual connectivity in accordance with an embodiment of the present disclosure. In FIG. 11D, a first base station is the primary node of a terminal device, and a second base station is the secondary node of the terminal device. In one embodiment, the terminal device may directly communicate with the first base station, may transfer control information, such as beam pair quality indications and beam pair information, between the terminal device and the first base station through the second base station (for example, through the communication links 1162 and 1164). That is, the information transferred between the base station and the terminal device in FIGS. 11A to 11C can be carried out through the dual connectivity in FIG. 11D.

It should be understood that FIGS. 11A to 11D are just several examples of the signaling flow. Those skilled in the art can conceive alternative forms without departing from the teachings of the present disclosure, which still fall within the scope of the present disclosure.

### Exemplary Methods

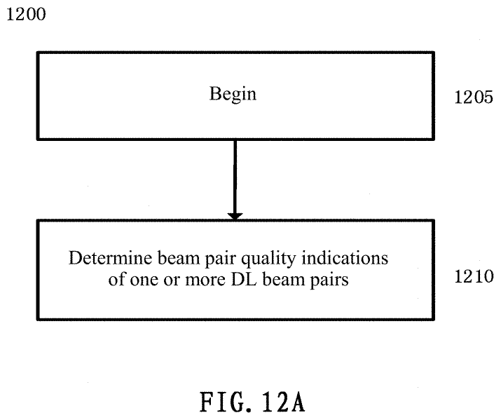

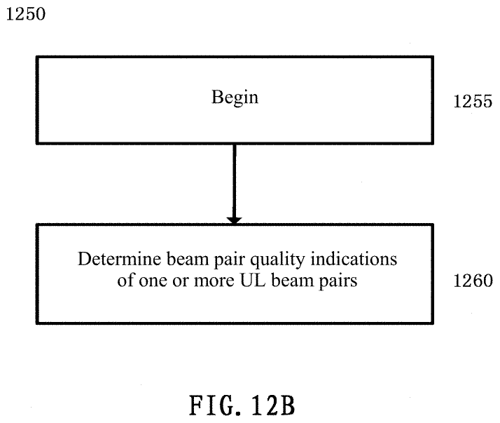

FIG. 12A illustrates an example method for communication in accordance with an embodiment of the present disclosure. As shown in FIG. 12A, the method 1200 begins at 1205, and at 1210, a beam pair quality indication of one or more downlink beam pairs can be determined. The beam pair quality indication may represent quality of service that can be offered by a corresponding downlink beam pair. The beam pair quality indication can comprise a plurality of BQI elements, and comprise at least degree of stability of a measurement metrics. The method may be performed by the electronic device 300, and the detailed example operation of the method may be reference to the above description of operations and functions of the electronic device 300, and a brief description is as follows.

In one embodiment, the plurality of beam pair quality indication elements further comprise an instantaneous value of the measurement metrics and/or a long-term value of the measurement metrics, and the measurement metrics comprises at least one of a reference signal received power, RSRP, a reference signal received quality, RSRQ, a signal-to-interference and noise ratio, SINR, or a signal-to-noise ratio, SNR.

In one embodiment, the terminal device transmits a beam pair quality indication to the base station. Transmitting the beam pair quality indication to the base station comprises: transmitting beam pair quality indications of a part of the beam pairs of the plurality of beam pairs to the base station, wherein the part of the beam pair are the beam pairs of the plurality of beam pairs with beam pair quality indications ranked higher; or transmitting beam pair quality indications of all beam pairs of the plurality of beam pairs to the base station.

In one embodiment, the terminal device receives information of one or more selected beam pairs from the base station, the information comprising at least indexes of the one or more selected beam pairs, wherein the beam pair quality indications of the one or more selected beam pairs are matched with quality of service for communication of the terminal device, or the beam pair quality indications of the one or more selected beam pairs are ranked higher.

In one embodiment, the terminal device selects one or more beam pairs from the plurality of beam pairs, wherein the beam pair quality indications of the one or more selected beam pairs are matched with quality of service for communication of the terminal device, or the beam pair quality indications of the one or more selected beam pairs are ranked higher; and transmit information of the one or more selected beam pairs to the base station, the information comprising at least indexes of the one or more selected beam pairs.

In one embodiment, the quality of service comprises a plurality of quality of service targets, the plurality of quality of service targets comprising an instantaneous data rate target, an average data rate target, and a data rate fluctuation degree target.

In one embodiment, the beam pair quality indication of the selected beam pair matching with quality of service for communication comprises: at least one beam pair quality indication element of the selected beam pair matches with a corresponding quality of service target for communication.

In one embodiment, the plurality of quality of service targets have corresponding priorities, and a beam pair quality indication of a selected beam pair matching with quality of service for communication comprises: there is a beam pair quality indication element for the selected beam pair, to match at least with a quality of service target with a highest priority for the communication.

In one embodiment, the terminal device obtains a beam pair quality indication of a beam pair by measuring one or more reference signals in the downlink, comprising: obtaining a beam pair quality indication of the beam pair based on measurement of a single reference signal; and/or obtaining the beam pair quality indication of the beam pair based on measurement of multiple reference signals which are Quasi Co-Located.

In one embodiment, the one or more reference signals in the downlink comprises at least one of SS/PBCH or CSI-RS.

In one embodiment, the terminal device obtains a beam pair quality indication element of SINR or SNR of a beam pair through a downlink interference measurement signal and/or based on data transmission in downlink.

In one embodiment, the terminal device obtains the long-term value of the measurement metrics through first order filtering in Layer 1 and/or Layer 3, and obtains the degree of stability of the measurement metrics through second order filtering in Layer 1 and/or Layer 3.

In one embodiment, the terminal device also receives at least one of the following through high-level signaling: quality of service targets for different services; priorities of the quality of service targets; or filtering parameters setting.

In one embodiment, the terminal device transmits the beam pair quality indication and/or information of the beam pair to the base station through a dual connectivity, comprising transmitting corresponding information to another base station serving the terminal device together with the base station through the dual connectivity, and the corresponding information is forwarded to the base station by the other base station; and/or the terminal device receives the information of the beam pair from the base station through the dual connectivity, comprising receiving corresponding information from another base station serving the terminal device together through the dual connectivity, and the corresponding information is transmitted by the base station to the other base station.

FIG. 12B illustrates another example method for communication in accordance with an embodiment of the present disclosure. As shown in FIG. 12B, the method 1250 starts at 1255, and at 1260, a beam pair quality indication of one or more uplink beam pairs can be determined. The beam pair quality indication may represent quality of service that can be offered by a corresponding uplink beam pair. The beam pair quality indication can comprise a plurality of BQI elements, and comprise at least degree of stability of a measurement metrics. The method may be performed by the electronic device 350, and the detailed example operation of the method may be reference to the above description of operations and functions of the electronic device 350, and a brief description is as follows.

In one embodiment, the plurality of beam pair quality indication elements further comprise an instantaneous value of the measurement metrics and/or a long-term value of the measurement metrics, the measurement metrics comprising at least one of a reference signal received power, RSRP, a reference signal received quality, RSRQ, a signal-to-interference and noise ratio, SINR, or a signal-to-noise ratio, SNR.

In one embodiment, the base station selects one or more beam pairs from the plurality of beam pairs, wherein the beam pair quality indications of the one or more selected beam pairs are matched with quality of service for communication of the terminal device, or the beam pair quality indications of the one or more selected beam pairs are ranked higher; and transmits information of the one or more selected beam pairs to the terminal device, the information comprising at least indexes of the one or more selected beam pairs.

In one embodiment, the base station receives beam pair quality indications of a plurality of downlink beam pairs from the terminal device, comprising: receiving beam pair quality indications of a part of the beam pairs of the plurality of downlink beam pairs from the terminal device, wherein the part of the beam pair are the beam pairs of the plurality of beam pairs with beam pair quality indications ranked higher; or receiving beam pair quality indications of all beam pairs of the plurality of downlink beam pairs from the terminal device.

In one embodiment, the base station selects one or more beam pairs from the plurality of downlink beam pairs, wherein the beam pair quality indications of the one or more selected beam pairs are matched with quality of service for communication of the terminal device, or the beam pair quality indications of the one or more selected beam pairs are ranked higher; and transmits information of the one or more selected beam pairs to the terminal device, the information comprising at least indexes of the one or more selected beam pairs.

In one embodiment, the quality of service comprises a plurality of quality of service targets, the plurality of quality of service targets comprising an instantaneous data rate target, an average data rate target, and a data rate fluctuation degree target.

In one embodiment, the beam pair quality indication of the selected beam pair matching with quality of service for communication comprises: at least one beam pair quality indication element of the selected beam pair matches with a corresponding quality of service target for communication.

In one embodiment, the plurality of quality of service targets have corresponding priorities, and a beam pair quality indication of a selected beam pair matching with quality of service for communication comprises: there is a beam pair quality indication element for the selected beam pair, to match at least with a quality of service target with a highest priority for the communication.

In one embodiment, the base station obtains a beam pair quality indication of a beam pair by measuring one or more reference signals in the uplink, comprising: obtaining a beam pair quality indication of the beam pair based on measurement of a single reference signal; and/or obtaining the beam pair quality indication of the beam pair based on measurement of multiple reference signals which are Quasi Co-Located.

In one embodiment, the one or more reference signals in the uplink comprises at least one of SRS or DMRS.

In one embodiment, the base station obtains a beam pair quality indication element of SINR or SNR of a beam pair through an uplink interference measurement signal and/or based on data transmission in uplink.

In one embodiment, the base station obtains the long-term value of the measurement metrics through first order filtering in Layer 1 and/or Layer 3, and to obtain the degree of stability of the measurement metrics through second order filtering in Layer 1 and/or Layer 3.

In one embodiment, the base station also at least one of the following through high-level signaling: quality of service targets for different services; priorities of the quality of service targets; or filtering parameters setting.

In one embodiment, the base station receives the beam pair quality indication and/or information of the beam pair in the downlink from the downlink device through a dual connectivity, comprising receiving corresponding information from another base station serving the terminal device together with the base station through the dual connectivity, and the corresponding information is transmitted to the other base station by the terminal device; and/or the base station transmits the information of the uplink and/or downlink beam pairs to the terminal device through the dual connectivity, comprising transmitting corresponding information to another base station serving the terminal device together through the dual connectivity, and the corresponding information is forwarded to the terminal device by the other base station.

Each of the exemplary electronic devices and methods according to embodiments of the present disclosure has been described above. It should be understood that the operations or functions of these electronic devices may be combined with each other to achieve more or less operations or functions than described. The operational steps of the methods can also be combined with each other in any suitable order, so that similarly more or fewer operations are achieved than described.

It should be understood that the machine-executable instructions in the machine-readable storage medium or program product according to the embodiments of the present disclosure can be configured to perform operations corresponding to the device and method embodiments described above. When referring to the above device and method embodiments, the embodiments of the machine-readable storage medium or the program product are clear to those skilled in the art, and therefore description thereof will not be repeated herein. A machine-readable storage media and a program product for carrying or including the above-described machine-executable instructions also fall within the scope of the present disclosure. Such storage medium can comprise, but is not limited to, a floppy disk, an optical disk, a magneto-optical disk, a memory card, a memory stick, and the like.

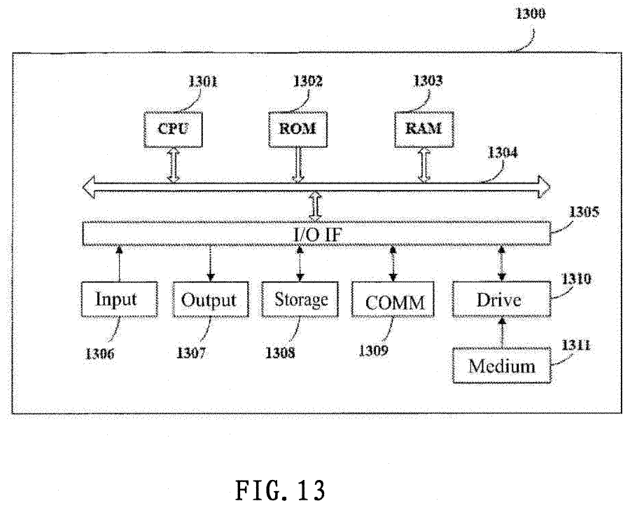

In addition, it should also be noted that the above series of processes and devices can also be implemented by software and/or firmware. In the case of being implemented by software and/or firmware, a program constituting the software is installed from a storage medium or a network to a computer having a dedicated hardware structure, such as the general-purpose personal computer 1300 shown in FIG. 13, which, when is installed with various programs, can execute various functions and so on. FIG. 13 is a block diagram showing an example structure of a personal computer which can be employed as an information processing device in the embodiment herein. In one example, the personal computer can correspond to the above-described exemplary terminal device in accordance with the present disclosure.

In FIG. 13, a central processing unit (CPU) 1301 executes various processes in accordance with a program stored in a read-only memory (ROM) 1302 or a program loaded from storage 1308 to a random access memory (RAM) 1303. In the RAM 1303, data required when the CPU 1301 executes various processes and the like is also stored as needed.

The CPU 1301, the ROM 1302, and the RAM 1303 are connected to each other via a bus 1304. Input/output interface 1305 is also connected to bus 1304.

The following components are connected to the input/output interface 1305: an input unit 1306 including a keyboard, a mouse, etc.; an output unit 1307 including a display such as a cathode ray tube (CRT), a liquid crystal display (LCD), etc., and a speaker, etc.; the storage 1308 including a hard disk etc.; and a communication unit 1309 including a network interface card such as a LAN card, a modem, etc. The communication unit 1309 performs communication processing via a network such as the Internet.

The driver 1310 is also connected to the input/output interface 1305 as needed. A removable medium 1311 such as a magnetic disk, an optical disk, a magneto-optical disk, a semiconductor memory or the like is mounted on the drive 1310 as needed, so that a computer program read therefrom is installed into the storage 1308 as needed.

In the case where the above-described series of processing is implemented by software, a program constituting the software is installed from a network such as the Internet or a storage medium such as the removable medium 1311.

It will be understood by those skilled in the art that such a storage medium is not limited to the removable medium 1311 shown in FIG. 13 in which a program is stored and distributed separately from the device to provide a program to the user. Examples of the removable medium 1311 include a magnetic disk (including a floppy disk (registered trademark)), an optical disk (including a compact disk read only memory (CD-ROM) and a digital versatile disk (DVD)), a magneto-optical disk (including a mini disk (MD) (registered trademark)) and a semiconductor memory. Alternatively, the storage medium may be a ROM 1302, a hard disk included in the storage section 1308, or the like, in which programs are stored, and distributed to users together with the device containing them.

The technology of the present disclosure can be applied to various products. For example, the base stations mentioned in this disclosure can be implemented as any type of evolved Node B (gNB), such as a macro gNB and a small gNB. The small gNB can be an gNB covering a cell smaller than the macro cell, such as a pico gNB, a micro gNB, and a home (femto) gNB. Alternatively, the base station can be implemented as any other type of base station, such as a NodeB and a Base Transceiver Station (BTS). The base station can include: a body (also referred to as a base station device) configured to control radio communication; and one or more remote radio heads (RRHs) disposed at a different location from the body. In addition, various types of terminals which will be described below can each operate as a base station by performing base station functions temporarily or semi-persistently.

For example, the terminal device mentioned in the present disclosure, also referred to as a user device in some examples, can be implemented as a mobile terminal (such as a smartphone, a tablet personal computer (PC), a notebook PC, a portable game terminal, a portable/dongle type mobile router and digital camera) or in-vehicle terminal (such as car navigation device). The user device may also be implemented as a terminal that performs machine-to-machine (M2M) communication (also referred to as a machine type communication (MTC) terminal). Further, the user device may be a radio communication module (such as an integrated circuit module including a single wafer) installed on each of the above terminals.

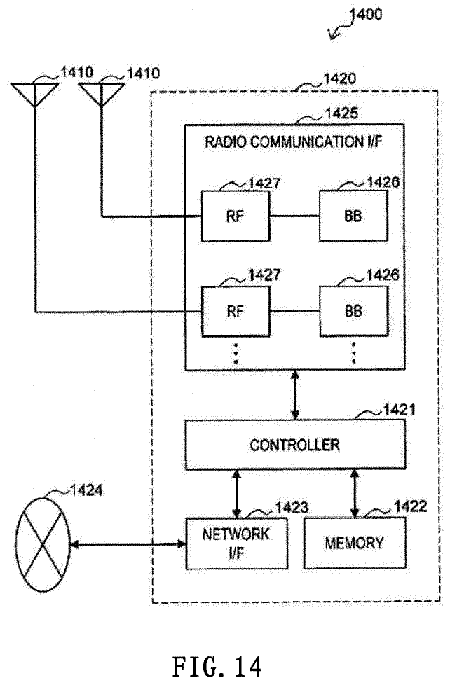

Use cases according to the present disclosure will be described below with reference to FIGS. 14 to 17.

### [Use Cases for Base Stations]

It should be understood that the term base station in this disclosure has the full breadth of its ordinary meaning, and includes at least a radio communication station used as portion of a wireless communication system or radio system to facilitate communication. Examples of the base station can be, for example but not limited to, the following: the base station can be either or both of a base transceiver station (BTS) and a base station controller (BSC) in the GSM system, and can be either or both of a radio network controller (RNC) or Node B in the WCDMA system, can be eNB in the LTE and LTE-Advanced system, or can be corresponding network nodes in future communication systems (e.g., the gNB that can appear in the 5G communication systems, eLTE eNB, etc.). Some of the functions in the base station of the present disclosure can also be implemented as an entity having a control function for communication in the scenario of a D2D, M2M, V2V and V2X communication, or as an entity that plays a spectrum coordination role in the scenario of a cognitive radio communication.

### First Use Case

FIG. 14 is a block diagram illustrating a first example of a schematic configuration of a gNB to which the technology of the present disclosure can be applied. The gNB 1400 includes a plurality of antennas 1410 and a base station device 1420. The base station device 1420 and each antenna 1410 may be connected to each other via an RF cable. In one implementation, the gNB 1400 (or base station device 1420) herein may correspond to the electronic devices 300A, 1300A, and/or 1500B described above.

Each of the antennas 1410 includes a single or multiple antenna elements (such as multiple antenna elements included in a Multiple Input and Multiple Output (MIMO) antenna), and is used for the base station device 1420 to transmit and receive radio signals. As shown in FIG. 14, the gNB 1400 may include multiple antennas 1410. For example, multiple antennas 1410 may be compatible with multiple frequency bands used by the gNB 1400.

The base station device 1420 includes a controller 1421, a memory 1422, a network interface 1423, and a radio communication interface 1425.

The controller 1421 may be, for example, a CPU or a DSP, and operates various functions of higher layers of the base station device 1420. For example, controller 1421 generates data packets from data in signals processed by the radio communication interface 1425, and transfers the generated packets via network interface 1423. The controller 1421 can bundle data from multiple baseband processors to generate the bundled packets, and transfer the generated bundled packets. The controller 1421 may have logic functions of performing control such as radio resource control, radio bearer control, mobility management, admission control, and scheduling. This control may be performed in corporation with a gNB or a core network node in the vicinity. The memory 1422 includes RAM and ROM, and stores a program that is executed by the controller 1421 and various types of control data such as a terminal list, transmission power data, and scheduling data.

The network interface 1423 is a communication interface for connecting the base station device 1420 to the core network 1424. Controller 1421 may communicate with a core network node or another gNB via the network interface 1423. In this case, the gNB 1400 and the core network node or other gNBs may be connected to each other through a logical interface such as an S1 interface and an X2 interface. The network interface 1423 may also be a wired communication interface or a radio communication interface for radio backhaul lines. If the network interface 1423 is a radio communication interface, the network interface 1423 may use a higher frequency band for radio communication than a frequency band used by the radio communication interface 1425.

The radio communication interface 1425 supports any cellular communication schemes, such as Long Term Evolution (LTE) and LTE-Advanced, and provides radio connection to a terminal positioned in a cell of the gNB 1400 via the antenna 1410. Radio communication interface 1425 may typically include, for example, a baseband (BB) processor 1426 and a RF circuit 1427. The BB processor 1426 may perform, for example, encoding/decoding, modulation/demodulation, and multiplexing/demultiplexing, and performs various types of signal processing of layers such as L1, Medium Access Control (MAC), Radio Link Control (RLC), and Packet Data Convergence Protocol (PDCP). Instead of controller 1421, the BB processor 1426 may have a part or all of the above-described logic functions. The BB processor 1426 may be a memory that stores a communication control program, or a module that includes a processor configured to execute the program and a related circuit. Updating the program may allow the functions of the BB processor 1426 to be changed. The module may be a card or a blade that is inserted into a slot of the base station device 1420. Alternatively, the module may also be a chip that is mounted on the card or the blade. Meanwhile, the RF circuit 1427 may include, for example, a mixer, a filter, and an amplifier, and transmits and receives radio signals via the antenna 1410. Although FIG. 14 illustrates an example in which one RF circuit 1427 is connected to one antenna 1410, the present disclosure is not limited to thereto; rather, one RF circuit 1427 may connect to a plurality of antennas 1410 at the same time.

As illustrated in FIG. 14, the radio communication interface 1425 may include the multiple BB processors 1426. For example, the multiple BB processors 1426 may be compatible with multiple frequency bands used by gNB 1400. As illustrated in FIG. 14, the radio communication interface 1425 may include the multiple RF circuits 1427. For example, the multiple RF circuits 1427 may be compatible with multiple antenna elements. Although FIG. 14 illustrates the example in which the radio communication interface 1425 includes the multiple BB processors 1426 and the multiple RF circuits 1427, the radio communication interface 1425 may also include a single BB processor 1426 or a single RF circuit 1427.

### Second Use Case

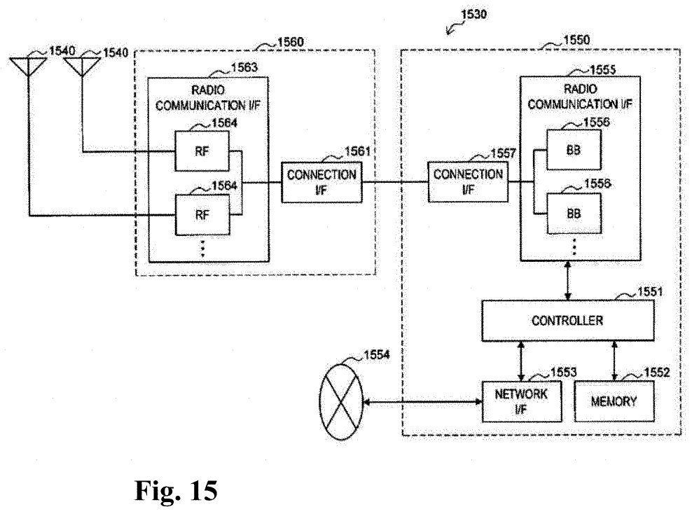

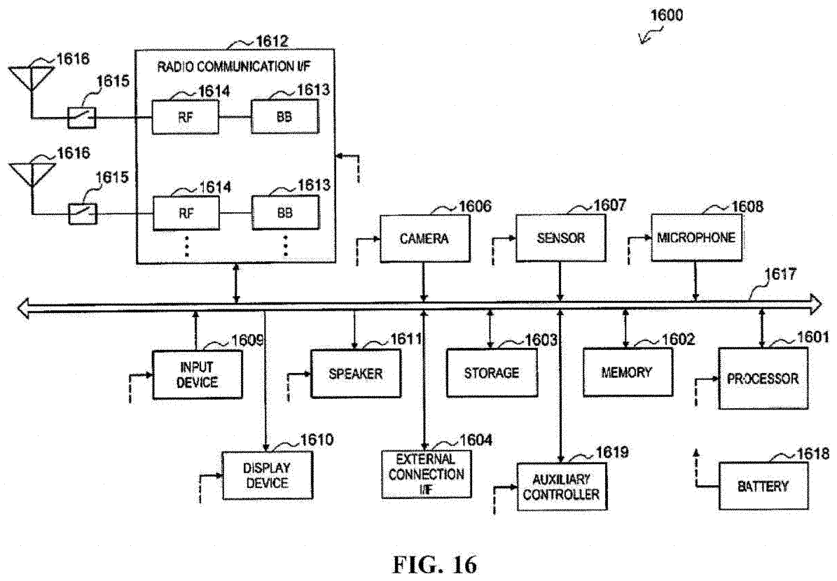

FIG. 15 is a block diagram illustrating a second example of a schematic configuration of a gNB to which the technology of the present disclosure may be applied. The gNB 1530 includes a plurality of antennas 1540, a base station device 1550, and an RRH 1560. The RRH 1560 and each antenna 1540 may be connected to each other via an RF cable. The base station device 1550 and the RRH 1560 may be connected to each other via a high speed line such as a fiber optic cable. In one implementation, the gNB 1530 (or base station device 1550) herein may correspond to the electronic devices 300A, 1300A, and/or 1500B described above.

Each of the antennas 1540 includes a single or multiple antenna elements such as multiple antenna elements included in a MIMO antenna and is used for the RRH 1560 to transmit and receive radio signals. The gNB 1530 may include multiple antennas 1540, as illustrated in FIG. 15. For example, multiple antennas 1540 may be compatible with multiple frequency bands used by the gNB 1530.

The base station device 1550 includes a controller 1551, a memory 1552, a network interface 1553, a radio communication interface 1555, and a connection interface 1557. The controller 1551, the memory 1552, and the network interface 1553 are the same as the controller 1421, the memory 1422, and the network interface 1423 described with reference to FIG. 14.

The radio communication interface 1555 supports any cellular communication scheme (such as LTE and LTE-Advanced) and provides radio communication to terminals positioned in a sector corresponding to the RRH 1560 via the RRH 1560 and the antenna 1540. The radio communication interface 1555 may typically include, for example, a BB processor 1556. The BB processor 1556 is the same as the BB processor 1426 described with reference to FIG. 14, except that the BB processor 1556 is connected to the RF circuit 1564 of the RRH 1560 via the connection interface 1557. The radio communication interface 1555 may include the multiple BB processors 1556, as illustrated in FIG. 15. For example, the multiple BB processors 1556 may be compatible with multiple frequency bands used by the gNB 1530. Although FIG. 15 illustrates the example in which the radio communication interface 1555 includes multiple BB processors 1556, the radio communication interface 1555 may also include a single BB processor 1556.

The connection interface 1557 is an interface for connecting the base station device 1550 (radio communication interface 1555) to the RRH 1560. The connection interface 1557 may also be a communication module for communication in the above-described high speed line that connects the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above-described high speed line.

The radio communication interface 1563 transmits and receives radio signals via the antenna 1540. Radio communication interface 1563 may typically include, for example, the RF circuitry 1564. The RF circuit 1564 may include, for example, a mixer, a filter, and an amplifier, and transmits and receives radio signals via the antenna 1540. Although FIG. 15 illustrates the example in which one RF circuit 1564 is connected to one antenna 1540, the present disclosure is not limited to thereto; rather, one RF circuit 1564 may connect to a plurality of antennas 1540 at the same time.

The radio communication interface 1563 may include multiple RF circuits 1564, as illustrated in FIG. 15. For example, multiple RF circuits 1564 may support multiple antenna elements. Although FIG. 15 illustrates the example in which the radio communication interface 1563 includes the multiple RF circuits 1564, the radio communication interface 1563 may also include a single RF circuit 1564.

### [Use Cases Related to User Devices]

### First Use Case

FIG. 16 is a block diagram illustrating an example of a schematic configuration of a smartphone 1600 to which the technology of the present disclosure may be applied. The smartphone 1600 includes a processor 1601, a memory 1602, a storage 1603, an external connection interface 1604, an camera 1606, a sensor 1607, a microphone 1608, an input device 1609, a display device 1610, a speaker 1611, a radio communication interface 1612, one or more antenna switch 1615, one or more antennas 1616, a bus 1617, a battery 1618, and an auxiliary controller 1619. In one implementation, smartphone 1600 (or processor 1601) herein may correspond to terminal device 300B and/or 1500A described above.

The processor 1601 may be, for example, a CPU or a system on chip (SoC), and controls functions of an application layer and the other layers of the smartphone 1600. The memory 1602 includes RAM and ROM, and stores a program that is executed by the processor 1601, and data. The storage 1603 may include a storage medium such as a semiconductor memory and a hard disk. The external connection interface 1604 is an interface for connecting an external device such as a memory card and a universal serial bus (USB) device to the smartphone 1600.

The camera 1606 includes an image sensor such as a charge coupled device (CCD) and a complementary metal oxide semiconductor (CMOS), and generates a captured image. Sensor 1607 may include a group of sensors such as a measurement sensor, a gyro sensor, a geomagnetic sensor, and an acceleration sensor. The microphone 1608 converts the sounds that are input to the smartphone 1600 to audio signals. The input device 1609 includes, for example, a touch sensor configured to detect touch on a screen of the display device 1610, a keypad, a keyboard, a button, or a switch, and receives an operation or an information input from a user. The display device 1610 includes a screen such as a liquid crystal display (LCD) and an organic light emitting diode (OLED) display, and displays an output image of the smartphone 1600. The speaker 1611 converts audio signals that are output from the smartphone 1600 to sounds.

The radio communication interface 1612 supports any cellular communication scheme such as LTE and LTE-Advanced, and performs radio communication. The radio communication interface 1612 may typically include, for example, a BB processor 1613 and an RF circuitry 1614. The BB processor 1613 may perform, for example, encoding/decoding, modulation/demodulation, and multiplexing/demultiplexing, and performs various types of signal processing for radio communication. Meanwhile, the RF circuit 1614 may include, for example, a mixer, a filter, and an amplifier, and transmits and receives radio signals via the antenna 1616. The radio communication interface 1612 may be a one chip module that integrates the BB processor 1613 and the RF circuit 1614 thereon. The radio communication interface 1612 may include multiple BB processors 1613 and multiple RF circuits 1614, as illustrated in FIG. 16. Although FIG. 16 illustrates the example in which the radio communication interface 1612 includes multiple BB processors 1613 and multiple RF circuits 1614, the radio communication interface 1612 may also include a single BB processor 1613 or a single RF circuit 1614.

Furthermore, in addition to a cellular communication scheme, the radio communication interface 1612 may support additional type of radio communication schemes, such as short-range wireless communication schemes, a near field communication schemes, and a wireless local area network (LAN) scheme. In this case, the radio communication interface 1612 may include the BB processor 1613 and the RF circuitry 1614 for each radio communication scheme.

Each of the antenna switches 1615 switches connection destinations of the antenna 1616 among multiple circuits (such as circuits for different radio communication schemes) included in the radio communication interface 1612.

Each of the antennas 1616 includes a single or multiple antenna elements (such as multiple antenna elements included in a MIMO antenna) and is used for the radio communication interface 1612 to transmit and receive radio signals. The smartphone 1600 may include multiple antennas 1616, as illustrated in FIG. 16. Although FIG. 16 illustrates the example in which the smartphone 1600 includes multiple antennas 1616, the smartphone 1600 may also include a single antenna 1616.

Furthermore, the smartphone 1600 may include the antenna 1616 for each radio communication scheme. In this case, the antenna switch 1615 may be omitted from the configuration of the smartphone 1600.

The bus 1617 connects the processor 1601, the memory 1602, the storage 1603, the external connection interface 1604, the camera 1606, the sensor 1607, the microphone 1608, the input device 1609, the display device 1610, the speaker 1611, the radio communication interface 1612, and the auxiliary control 1619 to each other. The battery 1618 supplies power to blocks of the smartphone 1600 illustrated in FIG. 16 via feeder lines, which are partially shown as a dashed line in the figure. The auxiliary controller 1619 operates a minimum necessary function of the smartphone 1600, for example, in a sleep mode.

### Second Use Case

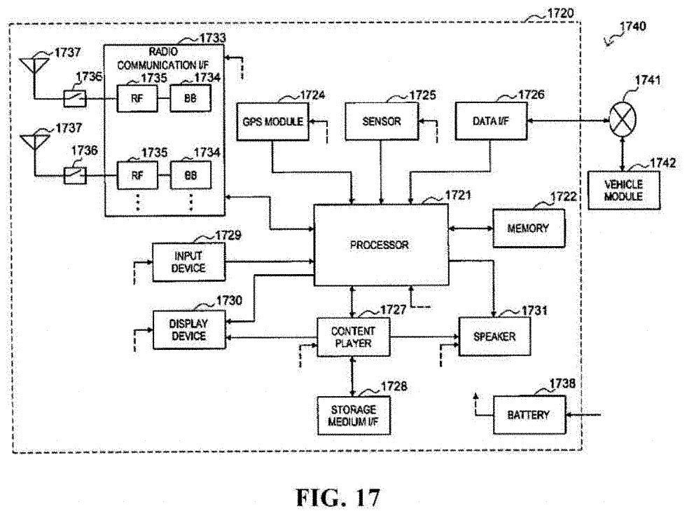

FIG. 17 is a block diagram illustrating an example of a schematic configuration of a car navigation device 1720 to which the technology of the present disclosure may be applied. The car navigation device 1720 includes a processor 1721, a memory 1722, a global positioning system (GPS) module 1724, a sensor 1725, a data interface 1726, a content player 1727, a storage medium interface 1728, an input device 1729, a display device 1730, a speaker 1731, and a radio communication interface 1733, one or more antenna switches 1736, one or more antennas 1737, and a battery 1738. In one implementation, car navigation device 1720 (or processor 1721) herein may correspond to terminal device 300B and/or 1500A described above.

The processor 1721 may be, for example, a CPU or a SoC, and controls a navigation function and other functions of the car navigation device 1720. The memory 1722 includes RAM and ROM, and stores a program that is executed by the processor 1721, and data.

The GPS module 1724 uses GPS signals received from a GPS satellite to measure a position, such as latitude, longitude, and altitude, of the car navigation device 1720. Sensor 1725 may include a group of sensors such as a gyro sensor, a geomagnetic sensor, and an air pressure sensor. The data interface 1726 is connected to, for example, an in-vehicle network 1741 via a terminal not shown, and acquires data generated by the vehicle, such as vehicle speed data.

The content player 1727 reproduces content stored in a storage medium (such as a CD and a DVD) that is inserted into the storage medium interface 1728. The input device 1729 includes, for example, a touch sensor configured to detect touch on a screen of the display device 1730, a button, or a switch, and receives an operation or an information input from a user. The display device 1730 includes a screen such as an LCD or an OLED display, and displays an image of the navigation function or content that is reproduced. The speaker 1731 outputs sounds of the navigation function or the content that is reproduced.

The radio communication interface 1733 supports any cellular communication scheme, such as LTE and LTE-Advanced, and performs radio communication. The radio communication interface 1733 may typically include, for example, a BB processor 1734 and an RF circuit 1735. The BB processor 1734 may perform, for example, encoding/decoding, modulation/demodulation, and multiplexing/demultiplexing, and performs various types of signal processing for radio communication. Meanwhile, the RF circuit 1735 may include, for example, a mixer, a filter, and an amplifier, and transmits and receives radio signals via the antenna 1737. The radio communication interface 1733 may also be a one chip module which integrates the BB processor 1734 and the RF circuit 1735 thereon. The radio communication interface 1733 may include multiple BB processors 1734 and multiple RF circuits 1735, as illustrated in FIG. 17. Although FIG. 17 illustrates the example in which the radio communication interface 1733 includes multiple BB processors 1734 and multiple RF circuits 1735, the radio communication interface 1733 may also include a single BB processor 1734 or a single RF circuit 1735.

Furthermore, in addition to a cellular communication scheme, the radio communication interface 1733 may support another type of radio communication scheme such as a short-range wireless communication scheme, a near-field communication scheme, and a wireless LAN scheme. In this case, the radio communication interface 1733 may include the BB processor 1734 and the RF circuit 1735 for each radio communication scheme.

Each of the antenna switches 1736 switches the connection destination of the antenna 1737 among multiple circuits (such as circuits for different radio communication schemes) included in the radio communication interface 1733.

Each of the antennas 1737 includes a single or multiple antenna elements, such as multiple antenna elements included in a MIMO antenna, and is used for the radio communication interface 1733 to transmit and receive radio signals. The car navigation device 1720 may include multiple antennas 1737, as illustrated in FIG. 17. Although FIG. 17 illustrates the example in which the car navigation device 1720 includes multiple antennas 1737, the car navigation device 1720 may also include a single antenna 1737.

Furthermore, the car navigation device 1720 may include the antenna 1737 for each radio communication scheme. In this case, the antenna switch 1736 may be omitted from the configuration of the car navigation device 1720.

The battery 1738 supplies power to blocks of the car navigation device 1720 illustrated in FIG. 17 via feeder lines that are partially shown as dashed lines in the figure. Battery 1738 accumulates power supplied from the vehicle.

The technology of the present disclosure may also be realized as an in-vehicle system (or vehicle) 1740 including one or more blocks of the car navigation device 1720, the in-vehicle network 1741, and the vehicle module 1742. The vehicle module 1742 generates vehicle data such as vehicle speed, engine speed, and faults information, and outputs the generated data to the in-vehicle network 1741.

The exemplary embodiments of the present disclosure have been described above with reference to the drawings, but the present disclosure is of course not limited to the above examples. Those skilled in the art can obtain various changes and modifications within the scope of the appended claims, and it should be understood that these changes and modifications will naturally fall within the technical scope of the present disclosure.

For example, a plurality of functions included in one unit in the above embodiments may be implemented by separate devices. Alternatively, the multiple functions implemented by the multiple units in the above embodiments may be implemented by separate devices, respectively. In addition, one of the above functions can be realized by multiple units. Needless to say, such a configuration is included in the technical scope of the present disclosure.

In this specification, the steps described in the flowchart include not only the processing performed in time series in the stated order, but also the processing performed in parallel or individually rather than necessarily in time series. In addition, even in the steps processed in time series, needless to say, the order can be appropriately changed.

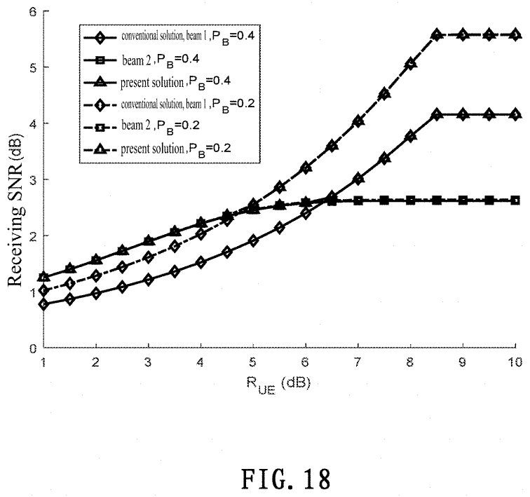

The performance simulation results of matching BQI elements with quality of service targets in accordance with an embodiment of the present disclosure will be described below with reference to FIG. 18. Consider a point-to-point system where a base station is equipped with M antennas and a terminal device is equipped with a single antenna. The channel from the base station to the terminal device h∈ [symbol] ^{M×1} consists of a line-of-sight (LoS) channel h_{LoS}∈ [symbol] ^{M×1} and a non-line-of-sight (NLoS) channel h_{NLoS}∈ [symbol] ^{M×1}, as follows:

$$h = {α}_{B} \sqrt{\frac{K}{K + 1}} {h}_{L o S} + \sqrt{\frac{1}{K + 1}} {h}_{N L o S}$$

where, α_{B} is the occlusion parameter of the LoS channel, and its values are as follows:

$${α}_{B} = \{ \begin{matrix}0 , & occluded \\ 1 , & non \text{-} occluded\end{matrix}$$

then P_{B}=Pr(α_{B}=0) is the occlusion probability of the LoS channel. K is the K index of the channel to show the power ratio of the LoS to NLoS channels, which follows the log-normal distribution 10 log K˜N(μ_{K}, σ_{K}²). h_{LoS} and h_{NLoS} can be expressed as:

h_{LoS}=[1,e^{-jπ cos θ}^{_{LoS}}, . . . ,e^{-j(M-1)π cos θ}^{_{LoS}}]

h_{NLoS}=[1,e^{-jπ cos θ}^{_{NLoS}}, . . . ,e^{-j(M-1)π cos θ}^{_{NLoS}}]

where, θ_{LoS} and θ_{NLoS} are transmission angles of LoS and NLoS, respectively. Using conjugate transposed beamforming, the two beamforming vectors for LoS and NLoS can be denoted as:

$${b}_{1} = \frac{1}{\sqrt{M}} {h}_{L o S}^{H} \\ {b}_{2} = \frac{1}{\sqrt{M}} {h}_{N L o S}^{H}$$

Assuming that R_{UE} is the SNR converted based on the data rate required by a terminal device, the SNR after beamforming using actually bᵢ, i=1, 2 is:

$${R}_{i} = min \{ {R}_{UE} , \frac{{Q}_{i}}{{σ}_{n}^{2}} \}$$

where Qᵢ=|hbᵢ|² is the received power when the combining vector on the measurement side of the terminal is ignored. The simulation parameters are shown in the table below. FIG. 18 compares the average performance of the conventional solution with the solution according to the present disclosure under 10,000 simulation results.

TABLE
Simulation parameters

| | |
|---|---|
| Number of TRP antennas M | 64 |
| K-factor mean μ_{K} | 9 |
| K-factor variance σ_{K}² | 3.5 |
| Noise power σₙ² | 1 |
| Occlusion probability P_{B} | 0.2, 0.4 |
| LoS channel transmission angle | π/2 |
| θ_{LoS} | |
| NLoS channel transmission | π/3 |
| angle θ_{NLoS} | |
| User requirements SNR R_{UE} | [0:10]dB |

In FIG. 18, the conventional solution always selects the beam 1 with a larger gain, that is, it can provide beams with higher instantaneous RSRP. However, beam 2 can provide better stability, that is, no interruption will occur. The solution according to the present disclosure can select beams with different performances based on different SNRs required by the terminal device to maximize the average Rᵢ. As shown in FIG. 18, when R_{UE} is small, the selection of beam 2 can lead to better performance; and, when the occlusion probability P_{B} is reduced, the performance of beam 1 would be improved. In summary, the solution according to the present disclosure can effectively match suitable beams according to different user needs to meet changing user demands, thereby improving user service experience and system performance.

Various example embodiments of the present disclosure may be implemented in the manner described in the following clauses:

Clause 1. A terminal device for a wireless communication system, comprising a processing circuit configured to:

determine a beam pair quality indication of a plurality of downlink beam pairs, the beam pair quality indication representing quality of service (QoS) that can be offered by a corresponding beam pair,

wherein the beam pair quality indication comprises a plurality of beam pair quality indication elements, the plurality of beam pair quality indication elements comprising at least degree of stability of a measurement metrics.

Clause 2. The terminal device of Clause 1, wherein the plurality of beam pair quality indication elements further comprise an instantaneous value of the measurement metrics and/or a long-term value of the measurement metrics, the measurement metrics comprising at least one of a reference signal received power, RSRP, a reference signal received quality, RSRQ, a signal-to-interference and noise ratio, SINR, or a signal-to-noise ratio, SNR.

Clause 3. The terminal device of Clause 1 or 2, wherein the processing circuit is further configured to transmit a beam pair quality indication to a base station, the transmitting the beam pair quality indication to the base station comprises:

transmitting beam pair quality indications of a part of the beam pairs of the plurality of beam pairs to the base station, wherein the part of the beam pair are the beam pairs of the plurality of beam pairs with beam pair quality indications ranked higher; or

transmitting beam pair quality indications of all beam pairs of the plurality of beam pairs to the base station.

Clause 4. The terminal device of Clause 3, wherein the processing circuit is further configured to:

receive information of one or more selected beam pairs from the base station, the information comprising at least indexes of the one or more selected beam pairs, wherein the beam pair quality indications of the one or more selected beam pairs are matched with quality of service for communication of the terminal device, or the beam pair quality indications of the one or more selected beam pairs are ranked higher.

Clause 5. The terminal device of Clause 3, wherein the processing circuit is further configured to:

select one or more beam pairs from the plurality of beam pairs, wherein the beam pair quality indications of the one or more selected beam pairs are matched with quality of service for communication of the terminal device, or the beam pair quality indications of the one or more selected beam pairs are ranked higher; and

transmit information of the one or more selected beam pairs to the base station, the information comprising at least indexes of the one or more selected beam pairs.

Clause 6. The terminal device of Clause 4 or 5, wherein the quality of service comprises a plurality of quality of service targets, the plurality of quality of service targets comprising an instantaneous data rate target, an average data rate target, and a data rate fluctuation degree target.

Clause 7. The terminal device of Clause 6, wherein the beam pair quality indication of the selected beam pair matching with quality of service for communication comprises:

at least one beam pair quality indication element of the selected beam pair matches with a corresponding quality of service target for communication.

Clause 8. The terminal device of Clause 6, wherein the plurality of quality of service targets have corresponding priorities, and a beam pair quality indication of a selected beam pair matching with quality of service for communication comprises:

there is a beam pair quality indication element for the selected beam pair, to match at least with a quality of service target with a highest priority for the communication.

Clause 9. The terminal device of Clause 1 or 2, wherein the processing circuit is further configured to obtain a beam pair quality indication of a beam pair by measuring one or more reference signals in the downlink, comprising:

obtaining a beam pair quality indication of the beam pair based on measurement of a single reference signal; and/or

obtaining the beam pair quality indication of the beam pair based on measurement of multiple reference signals which are Quasi Co-Located.

Clause 10. The terminal device of Clause 9, wherein the one or more reference signals in the downlink comprises at least one of SS/PBCH or CSI-RS.

Clause 11. The terminal device of Clause 2, wherein the processing circuit is further configured to obtain a beam pair quality indication element of SINR or SNR of a beam pair through a downlink interference measurement signal and/or based on data transmission in downlink.

Clause 12. The terminal device of Clause 10 or 11, wherein the processing circuit is further configured to obtain the long-term value of the measurement metrics through first order filtering in Layer 1 and/or Layer 3, and to obtain the degree of stability of the measurement metrics through second order filtering in Layer 1 and/or Layer 3.

Clause 13. The terminal device of any preceding Clauses, wherein the processing circuit is further configured to receive at least one of the following through high-level signaling:

quality of service targets for different services;

priorities of the quality of service targets; or

filtering parameters setting.

Clause 14. The terminal device of Clause 13, wherein the processing circuit is further configured to transmit the beam pair quality indication and/or information of the beam pair to the base station through a dual connectivity, comprising transmitting corresponding information to another base station serving the terminal device together with the base station through the dual connectivity, and the corresponding information is forwarded to the base station by the other base station; and/or

the processing circuit is further configured to receive the information of the beam pair from the base station through the dual connectivity, comprising receiving corresponding information from another base station serving the terminal device together through the dual connectivity, and the corresponding information is transmitted by the base station to the other base station.

Clause 15. A base station for a wireless communication system, comprising a processing circuit configured to:

determine a beam pair quality indication of a plurality of uplink beam pairs, the beam pair quality indication representing quality of service that can be offered by a corresponding beam pair,

wherein the beam pair quality indication comprises a plurality of beam pair quality indication elements, the plurality of beam pair quality indication elements comprising at least degree of stability of a measurement metrics.

Clause 16. The base station of Clause 15, wherein the plurality of beam pair quality indication elements further comprise an instantaneous value of the measurement metrics and/or a long-term value of the measurement metrics, the measurement metrics comprising at least one of a reference signal received power, RSRP, a reference signal received quality, RSRQ, a signal-to-interference and noise ratio, SINR, or a signal-to-noise ratio, SNR.

Clause 17. The base station of Clause 15 or 16, wherein the processing circuit is further configured to:

selecting one or more beam pairs from the plurality of beam pairs, wherein the beam pair quality indications of the one or more selected beam pairs are matched with quality of service for communication of the terminal device, or the beam pair quality indications of the one or more selected beam pairs are ranked higher; and

transmitting information of the one or more selected beam pairs to the terminal device, the information comprising at least indexes of the one or more selected beam pairs.

Clause 18. The base station of Clause 15 or 16, wherein the processing circuit is further configured to receive beam pair quality indications of a plurality of downlink beam pairs from the terminal device, comprising:

receiving beam pair quality indications of a part of the beam pairs of the plurality of downlink beam pairs from the terminal device, wherein the part of the beam pair are the beam pairs of the plurality of beam pairs with beam pair quality indications ranked higher; or

receiving beam pair quality indications of all beam pairs of the plurality of downlink beam pairs from the terminal device.

Clause 19. The base station of Clause 18, wherein the processing circuit is further configured to:

select one or more beam pairs from the plurality of downlink beam pairs, wherein the beam pair quality indications of the one or more selected beam pairs are matched with quality of service for communication of the terminal device, or the beam pair quality indications of the one or more selected beam pairs are ranked higher; and

transmit information of the one or more selected beam pairs to the terminal device, the information comprising at least indexes of the one or more selected beam pairs.

Clause 20. The base station of Clause 17, wherein the quality of service comprises a plurality of quality of service targets, the plurality of quality of service targets comprising an instantaneous data rate target, an average data rate target, and a data rate fluctuation degree target.

Clause 21. The base station of Clause 20, wherein the beam pair quality indication of the selected beam pair matching with quality of service for communication comprises:

at least one beam pair quality indication element of the selected beam pair matches with a corresponding quality of service target for communication.

Clause 22. The base station of Clause 20, wherein the plurality of quality of service targets have corresponding priorities, and a beam pair quality indication of a selected beam pair matching with quality of service for communication comprises:

there is a beam pair quality indication element for the selected beam pair, to match at least with a quality of service target with a highest priority for the communication.

Clause 23. The base station of Clause 15 or 16, wherein the processing circuit is further configured to obtain a beam pair quality indication of a beam pair by measuring one or more reference signals in the uplink, comprising:

obtaining a beam pair quality indication of the beam pair based on measurement of a single reference signal; and/or

obtaining the beam pair quality indication of the beam pair based on measurement of multiple reference signals which are Quasi Co-Located.

Clause 24. The base station of Clause 23, wherein the one or more reference signals in the uplink comprises at least one of SRS or DMRS.

Clause 25. The base station of Clause 16, wherein the processing circuit is further configured to obtain a beam pair quality indication element of SINK or SNR of a beam pair through an uplink interference measurement signal and/or based on data transmission in uplink.

Clause 26. The base station of Clause 24 or 25, wherein the processing circuit is further configured to obtain the long-term value of the measurement metrics through first order filtering in Layer 1 and/or Layer 3, and to obtain the degree of stability of the measurement metrics through second order filtering in Layer 1 and/or Layer 3.

Clause 27. The base station of any preceding Clauses, wherein the processing circuit is further configured to transmit at least one of the following through high-level signaling:

quality of service targets for different services;

priorities of the quality of service targets; or

filtering parameters setting.

Clause 28. The base station of Clause 27, wherein the processing circuit is further configured to receive the beam pair quality indication and/or information of the beam pair in the downlink from the downlink device through a dual connectivity, comprising receiving corresponding information from another base station serving the terminal device together with the base station through the dual connectivity, and the corresponding information is transmitted to the other base station by the terminal device; and/or

the processing circuit is further configured to transmit the information of the uplink and/or downlink beam pairs to the terminal device through the dual connectivity, comprising transmitting corresponding information to another base station serving the terminal device together through the dual connectivity, and the corresponding information is forwarded to the terminal device by the other base station.

Clause 29. A method for wireless communication performed by a terminal device, comprising:

determining a beam pair quality indication of a plurality of downlink beam pairs, the beam pair quality indication representing quality of service (QoS) that can be offered by a corresponding beam pair,

wherein the beam pair quality indication comprises a plurality of beam pair quality indication elements, the plurality of beam pair quality indication elements comprising at least degree of stability of a measurement metrics.

Clause 30. A method for wireless communication performed by a base station, comprising:

determining a beam pair quality indication of a plurality of uplink beam pairs, the beam pair quality indication representing quality of service that can be offered by a corresponding beam pair,

wherein the beam pair quality indication comprises a plurality of beam pair quality indication elements, the plurality of beam pair quality indication elements comprising at least degree of stability of a measurement metrics.

Clause 31. A computer-readable storage medium having one or more instructions stored thereon, which when executed by one or more processors of an electronic device, causes the electronic device to perform methods according to any of Clauses 29 to 30.

Clause 32. An apparatus for use in a wireless communication system, comprising means for performing operations of methods according to any of Clauses 29 to 30.

Although the present disclosure and its advantages have been described in detail, it will be appreciated that various changes, replacements and transformations can be made without departing from the spirit and scope of the present disclosure as defined by the appended claims. In addition, the terms “include”, “comprise” or any other variants of the embodiments herein are intended to be non-exclusive inclusion, such that the process, method, article or device including a series of elements includes not only these elements, but also those that are not listed specifically, or those that are inherent to the process, method, article or device. In case of further limitations, the element defined by the sentence “include one” does not exclude the presence of additional same elements in the process, method, article or device including this element.

1. A terminal device for a wireless communication system, comprising a processing circuit configured to:
determine a beam pair quality indication of a plurality of downlink beam pairs, the beam pair quality indication representing quality of service (QoS) that can be offered by a corresponding beam pair,
wherein the beam pair quality indication comprises a plurality of beam pair quality indication elements, the plurality of beam pair quality indication elements comprising at least degree of stability of a measurement metrics.

2. The terminal device of claim 1, wherein the plurality of beam pair quality indication elements further comprise an instantaneous value of the measurement metrics and/or a long-term value of the measurement metrics, the measurement metrics comprising at least one of a reference signal received power, RSRP, a reference signal received quality, RSRQ, a signal-to-interference and noise ratio, SINR, or a signal-to-noise ratio, SNR.

3. The terminal device of claim 1, wherein the processing circuit is further configured to transmit a beam pair quality indication to a base station, the transmitting the beam pair quality indication to the base station comprises:
transmitting beam pair quality indications of a part of the beam pairs of the plurality of beam pairs to the base station, wherein the part of the beam pair are the beam pairs of the plurality of beam pairs with beam pair quality indications ranked higher; or
transmitting beam pair quality indications of all beam pairs of the plurality of beam pairs to the base station.

4. The terminal device of claim 3, wherein the processing circuit is further configured to:
receive information of one or more selected beam pairs from the base station, the information comprising at least indexes of the one or more selected beam pairs, wherein the beam pair quality indications of the one or more selected beam pairs are matched with quality of service for communication of the terminal device, or the beam pair quality indications of the one or more selected beam pairs are ranked higher, and/or
wherein the processing circuit is further configured to:
select one or more beam pairs from the plurality of beam pairs, wherein the beam pair quality indications of the one or more selected beam pairs are matched with quality of service for communication of the terminal device, or the beam pair quality indications of the one or more selected beam pairs are ranked higher; and
transmit information of the one or more selected beam pairs to the base station, the information comprising at least indexes of the one or more selected beam pairs.

5. (canceled)

6. The terminal device of claim 4, wherein the quality of service comprises a plurality of quality of service targets, the plurality of quality of service targets comprising an instantaneous data rate target, an average data rate target, and a data rate fluctuation degree target,
wherein the beam pair quality indication of the selected beam pair matching with quality of service for communication comprises at least one beam pair quality indication element of the selected beam pair matches with a corresponding quality of service target for communication; and/or
wherein the plurality of quality of service targets have corresponding priorities, and a beam pair quality indication of a selected beam pair matching with quality of service for communication comprises: there is a beam pair quality indication element for the selected beam pair, to match at least with a quality of service target with a highest priority for the communication.

7.-8. (canceled)

9. The terminal device of claim 1, wherein the processing circuit is further configured to obtain a beam pair quality indication of a beam pair by measuring one or more reference signals in the downlink, comprising:
obtaining a beam pair quality indication of the beam pair based on measurement of a single reference signal; and/or
obtaining the beam pair quality indication of the beam pair based on measurement of multiple reference signals which are Quasi Co-Located,
wherein the one or more reference signals in the downlink comprises at least one of SS/PBCH or CSI-RS.

10. (canceled)

11. The terminal device of claim 2, wherein the processing circuit is further configured to obtain a beam pair quality indication element of SINR or SNR of a beam pair through a downlink interference measurement signal and/or based on data transmission in downlink.

12. The terminal device of claim 9, wherein the processing circuit is further configured to obtain the long-term value of the measurement metrics through first order filtering in Layer 1 and/or Layer 3, and to obtain the degree of stability of the measurement metrics through second order filtering in Layer 1 and/or Layer 3,
wherein the processing circuit is further configured to receive at least one of the following through high-level signaling:
quality of service targets for different services;
priorities of the quality of service targets; or
filtering parameters setting.

13. (canceled)

14. The terminal device of claim 12, wherein the processing circuit is further configured to transmit the beam pair quality indication and/or information of the beam pair to the base station through a dual connectivity, comprising transmitting corresponding information to another base station serving the terminal device together with the base station through the dual connectivity, and the corresponding information is forwarded to the base station by the other base station; and/or
the processing circuit is further configured to receive the information of the beam pair from the base station through the dual connectivity, comprising receiving corresponding information from another base station serving the terminal device together through the dual connectivity, and the corresponding information is transmitted by the base station to the other base station.

15. A base station for a wireless communication system, comprising a processing circuit configured to:
determine a beam pair quality indication of a plurality of uplink beam pairs, the beam pair quality indication representing quality of service that can be offered by a corresponding beam pair,
wherein the beam pair quality indication comprises a plurality of beam pair quality indication elements, the plurality of beam pair quality indication elements comprising at least degree of stability of a measurement metrics.

16. The base station of claim 15, wherein the plurality of beam pair quality indication elements further comprise an instantaneous value of the measurement metrics and/or a long-term value of the measurement metrics, the measurement metrics comprising at least one of a reference signal received power, RSRP, a reference signal received quality, RSRQ, a signal-to-interference and noise ratio, SINK, or a signal-to-noise ratio, SNR.

17. The base station of claim 15, wherein the processing circuit is further configured to:
selecting one or more beam pairs from the plurality of beam pairs, wherein the beam pair quality indications of the one or more selected beam pairs are matched with quality of service for communication of the terminal device, or the beam pair quality indications of the one or more selected beam pairs are ranked higher; and
transmitting information of the one or more selected beam pairs to the terminal device, the information comprising at least indexes of the one or more selected beam pairs.

18. The base station of claim 15, wherein the processing circuit is further configured to receive beam pair quality indications of a plurality of downlink beam pairs from the terminal device, comprising:
receiving beam pair quality indications of a part of the beam pairs of the plurality of downlink beam pairs from the terminal device, wherein the part of the beam pair are the beam pairs of the plurality of beam pairs with beam pair quality indications ranked higher; or
receiving beam pair quality indications of all beam pairs of the plurality of downlink beam pairs from the terminal device,
wherein the processing circuit is further configured to:
select one or more beam pairs from the plurality of downlink beam pairs, wherein the beam pair quality indications of the one or more selected beam pairs are matched with quality of service for communication of the terminal device, or the beam pair quality indications of the one or more selected beam pairs are ranked higher; and
transmit information of the one or more selected beam pairs to the terminal device, the information comprising at least indexes of the one or more selected beam pairs.

19. (canceled)

20. The base station of claim 17, wherein the quality of service comprises a plurality of quality of service targets, the plurality of quality of service targets comprising an instantaneous data rate target, an average data rate target, and a data rate fluctuation degree target,
wherein the beam pair quality indication of the selected beam pair matching with quality of service for communication comprises: at least one beam pair quality indication element of the selected beam pair matches with a corresponding quality of service target for communication, and/or
wherein the plurality of quality of service targets have corresponding priorities, and a beam pair quality indication of a selected beam pair matching with quality of service for communication comprises: there is a beam pair quality indication element for the selected beam pair, to match at least with a quality of service target with a highest priority for the communication.

21.-22. (canceled)

23. The base station of claim 15, wherein the processing circuit is further configured to obtain a beam pair quality indication of a beam pair by measuring one or more reference signals in the uplink, comprising:
obtaining a beam pair quality indication of the beam pair based on measurement of a single reference signal; and/or
obtaining the beam pair quality indication of the beam pair based on measurement of multiple reference signals which are Quasi Co-Located,
wherein the one or more reference signals in the uplink comprises at least one of SRS or DMRS.

24. (canceled)

25. The base station of claim 16, wherein the processing circuit is further configured to obtain a beam pair quality indication element of SINK or SNR of a beam pair through an uplink interference measurement signal and/or based on data transmission in uplink.

26. The base station of claim 23, wherein the processing circuit is further configured to obtain the long-term value of the measurement metrics through first order filtering in Layer 1 and/or Layer 3, and to obtain the degree of stability of the measurement metrics through second order filtering in Layer 1 and/or Layer 3,
wherein the processing circuit is further configured to transmit at least one of the following through high-level signaling:
quality of service targets for different services;
priorities of the quality of service targets; or
filtering parameters setting.

27. (canceled)

28. The base station of claim 26, wherein the processing circuit is further configured to receive the beam pair quality indication and/or information of the beam pair in the downlink from the downlink device through a dual connectivity, comprising receiving corresponding information from another base station serving the terminal device together with the base station through the dual connectivity, and the corresponding information is transmitted to the other base station by the terminal device; and/or
the processing circuit is further configured to transmit the information of the uplink and/or downlink beam pairs to the terminal device through the dual connectivity, comprising transmitting corresponding information to another base station serving the terminal device together through the dual connectivity, and the corresponding information is forwarded to the terminal device by the other base station.

29. A method for wireless communication performed by a terminal device, comprising:
determining a beam pair quality indication of a plurality of downlink beam pairs, the beam pair quality indication representing quality of service (QoS) that can be offered by a corresponding beam pair,
wherein the beam pair quality indication comprises a plurality of beam pair quality indication elements, the plurality of beam pair quality indication elements comprising at least degree of stability of a measurement metrics.

30. A method for wireless communication performed by a base station, comprising:
determining a beam pair quality indication of a plurality of uplink beam pairs, the beam pair quality indication representing quality of service that can be offered by a corresponding beam pair,
wherein the beam pair quality indication comprises a plurality of beam pair quality indication elements, the plurality of beam pair quality indication elements comprising at least degree of stability of a measurement metrics.

31.-32. (canceled)
